(19) United States
(12) Patent Application Publication
(10) Pub. No.: US 2007/0103390 A1
(43) Pub. Date: May 10, 2007

(54) Plasma display apparatus and driving method thereof

(75) Inventors: Kirack Park, Chilgok-gun (KR); Jongwoon Bae, Gumi-si (KR); Seonghwan Ryu, Gumi-si (KR); Yoonjoo Cho, Seoul (KR); Dooyong Hwang, Yongin-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/360,818

(22) Filed: Feb. 24, 2006

(30) Foreign Application Priority Data
Nov. 7, 2005 (KR) 10-2005-0106205

(51) Int. Cl. G09G 3/28

(52) U.S. Cl. 345/60

(57) ABSTRACT

The present invention relates to a plasma display apparatus and driving method thereof. A scan pulse is supplied to scan electrodes according to one or more of a plurality of scan pulse supply orders. Therefore, the present invention is advantageous in that it can prevent the occurrence of an excessive displacement current and can prevent electrical damage to a data driver IC accordingly. Furthermore, according to the present invention, by controlling an application time point of a data pulse applied to data electrodes in an address period, noise of waveforms applied to scan electrodes and sustain electrodes can be suppressed to stabilize an address discharge. Therefore, there are advantages in that the driving of a panel can be stabilized and a reduction in the stability of driving can be prohibited. To accomplish these objects, a plasma display apparatus of the present invention comprises a plurality of scan electrodes, a plurality of data electrodes intersecting the scan electrodes, a scan driver for supplying scan pulses to the plurality of scan electrodes according to any one of two or more different scan pulse supply orders, and a data driver for supplying at least one data pulse, which corresponds to one scan pulse and has an application time point different from an application time point of the scan pulse, to the data electrodes.

This Nonprovisional application claims priority under 35 U.S.C. § 119(a) on Korean Patent Application No. 10-2005-0106205 filed in Korea on Nov. 7, 2005, the entire contents of which are hereby incorporated by reference.

### BACKGROUND OF THE INVENTION

1. Field of the Invention

The present invention relates to a display apparatus, and more particularly, to a plasma display apparatus and driving method thereof.

2. Description of the Background Art

In general, a plasma display panel has a front panel and a rear panel. A barrier rib formed between the front panel and the rear panel forms one cell. Each cell is filled with an inert gas containing a primary discharge gas, such as neon (Ne), helium (He) or a mixed gas of Ne+He, and a small amount of xenon (Xe). A plurality of the cells forms one pixel. For example, a red (R) discharge cell, a green (G) discharge cell and a blue (B) discharge cell form one pixel.

In the plasma display apparatus constructed above, when the inert gas is discharged with a high frequency voltage, it generates vacuum ultraviolet rays. The vacuum ultraviolet rays excite phosphors formed between the barrier ribs to display images. The plasma display apparatus can be made thin and light, and has thus been in the spotlight as the next-generation display devices.

A plurality of electrodes, such as scan electrodes Y, sustain electrodes Z and address electrodes X, is formed in a plasma display panel. Predetermined driving voltages are applied to the plurality of electrodes to generate discharges, displaying images. A driver Integrated Circuit (IC) for supplying the driving voltages to the electrodes of the plasma display panel is connected to the electrodes.

For example, a data driver IC can be connected to the address electrodes X of the electrodes of the plasma display panel. A scan driver IC can be connected to the scan electrodes Y of the electrodes of the plasma display panel.

Meanwhile, when the plasma display panel is driven, a displacement current (Id) flows through the driver IC. An amount of the displacement current is significantly varied due to a variety of factors.

For example, the displacement current flowing through the data driver IC can rise or decrease depending on equivalent capacitance (C) of the plasma display panel and a switching number of the data driver IC. More particularly, the displacement current flowing through the data driver IC can be increased as the equivalent capacitance (C) of the plasma display panel is increased and can also be increased as the switching number of the data driver is increased.

Meanwhile, the equivalent capacitance (C) of the plasma display panel can be decided by equivalent capacitance (C) between electrode. This will be described below with reference to the appended FIG. 1.

FIG. 1 is a view illustrating equivalent capacitance of a plasma display panel.

Referring to FIG. 1, the equivalent capacitance (C) of the plasma display panel has equivalent capacitance (Cm1) between data electrodes, such as a data electrode X1 and a data electrode X2, equivalent capacitance (Cm2) between the data electrode and the scan electrode, such as the data electrode X1 and a scan electrode Y1, and equivalent capacitance (Cm2) between the data electrode and a sustain electrode, such as the data electrode X1 and a sustain electrode Z1.

Meanwhile, the state of a voltage applied to the scan electrode Y or the data electrode X is changed according to the operation of a switching element included in a drive IC, such as a scan drive IC, for driving the scan electrode Y by supplying a scan pulse to the scan electrode Y in an address period, and a drive IC, such as a data driver IC, for driving the data electrode X by supplying a data pulse to the data electrode X in an address period. Therefore, a displacement current (Id) generated by the equivalent capacitance (Cm1) and the equivalent capacitance (Cm2) flows through the data driver IC via the data electrode X.

As mentioned above, if equivalent capacitance of the plasma display panel rises, an amount of the displacement current (Id) flowing through the data driver IC rises. Furthermore, if a switching number of the data driver IC is increased, an amount of the displacement current (Id) rises. The switching number of the data driver IC can be varied depending on incoming image data.

More particularly, in the case of a specific pattern, such as one in which a logic value of image data is alternately repeated between 0 and 1, an amount of a displacement current flowing through the data driver IC is excessively increased. Therefore, a problem arises because electrical damage, such as burning, is given to data driver IC.

### SUMMARY OF THE INVENTION

Accordingly, an object of the present invention is to solve at least the problems and disadvantages of the background art.

It is an object of the present invention to provide a plasma display apparatus and driving method thereof in which electrical damage to a driver IC can be prevented.

A plasma display apparatus according to an aspect of the present invention comprises a plurality of scan electrodes, a plurality of data electrodes intersecting the scan electrodes, a scan driver for supplying scan pulses to the plurality of scan electrodes according to any one of two or more different scan pulse supply orders, and a data driver for supplying at least one data pulse, which corresponds to one scan pulse and has an application time point different from an application time point of the scan pulse, to the data electrodes.

A plasma display apparatus according to another aspect of the present invention comprises a plasma display panel in which a plurality of scan electrodes and a plurality of data electrodes intersecting the scan electrodes are formed, a scan driver for supplying a scan pulse to the scan electrodes by setting a scan order of the plurality of scan electrodes in a second data pattern different from a first data pattern of data patterns of incoming image data to be different from the scan order of the first data pattern, and a data driver for supplying at least one data pulse, which corresponds to one scan pulse and has an application time point different from an application time point of the scan pulse, to the data electrodes.

A method of driving a plasma display apparatus comprising a plurality of scan electrodes and a plurality of data electrodes intersecting the scan electrodes according to another aspect of the present invention comprises the steps of supplying scan pulses to the plurality of scan electrodes according to any one of two or more different scan pulse supply orders, and supplying at least one data pulse, which corresponds to one scan pulse and has an application time point different from an application time point of the scan pulse, to the data electrodes.

A method of driving a plasma display apparatus comprising a plurality of scan electrodes and a plurality of data electrodes intersecting the scan electrodes according to another aspect of the present invention comprises the steps of supplying a scan pulse to the scan electrodes by setting a scan order of the plurality of scan electrodes in a second data pattern different from a first data pattern of data patterns of incoming image data to be different from the scan order of the first data pattern, and supplying at least one data pulse, which corresponds to one scan pulse and has an application time point different from an application time point of the scan pulse, to the data electrodes.

A plasma display apparatus and driving method thereof according to the present invention are advantageous in that it can prevent the occurrence of an excessive displacement current and can prevent electrical damage to a data driver IC accordingly.

Furthermore, according to the present invention, by controlling an application time point of data pulses applied to data electrodes in an address period, noise of waveforms applied to scan electrodes and sustain electrodes can be suppressed to stabilize an address discharge. Therefore, there are advantages in that the driving of a panel can be stabilized and a reduction in the stability of driving can be prohibited.

### BRIEF DESCRIPTION OF THE DRAWINGS

The embodiment of the invention will be described in detail with reference to the following drawings in which like numerals refer to like elements.

FIG. 1 is a view illustrating equivalent capacitance of a plasma display panel;

FIG. 2 is a block diagram of a plasma display apparatus according to the present invention;

FIGS. 3a and 3b are views illustrating an exemplary structure of a plasma display panel according to the present invention;

FIG. 4 is a view illustrating a method of implementing gray levels of an image in a plasma display apparatus according to the present invention;

FIG. 5 is a view illustrating a method of driving a plasma display apparatus according to the present invention;

FIGS. 6a to 6e are timing diagrams showing an example of a method of applying a data pulse to each data electrode at a different time point from an application time point of a scan pulse in the method of driving the plasma display apparatus according to the present invention;

FIGS. 7a and 7b are views illustrating noise reduced by a driving waveform according to the driving method of the present invention;

FIG. 8 is a view illustrating that data electrodes are divided into four data electrode groups in order to explain another driving method of the plasma display apparatus according to the present invention;

FIGS. 9a to 9c illustrate examples in which data electrodes are divided into a plurality of electrode groups and a data pulse is applied to each electrode group at a different time point from an application time point of a scan pulse in the method of driving the plasma display apparatus according to the present invention;

FIG. 10 illustrates an example in which an application time point of a scan pulse and an application time point of a data pulse are set to be different from each other depending on each sub-field within a frame in the method of driving the plasma display apparatus according to the present invention;

FIGS. 11a to 11c are timing diagrams illustrating, in more detail, the driving waveform of FIG. 10;

FIG. 12 is a view illustrating an amount of a displacement current depending on incoming image data;

FIGS. 13a and 11b are views illustrating an exemplary method of changing a scan order considering image data and a displacement current accordingly;

FIG. 14 is a view illustrating another application example in the method of driving the plasma display apparatus according to the present invention;

FIG. 15 is a view illustrating, in detail, the construction and operation of a scan driver for realizing the method of driving the plasma display apparatus according to the present invention;

FIG. 16 shows a basic circuit block comprised in a data comparator included in the scan driver of the plasma display apparatus of the present invention;

FIG. 17 is a view illustrating, in more detail, the operation of first to third decision units of a data comparator;

FIG. 18 is a table showing pattern contents of image data depending on output signals of first to third decision units comprised in the basic circuit block of the data comparator according to the present invention;

FIG. 19 is a block diagram illustrating a data comparator and a scan order decision unit of the scan driver in the plasma display apparatus of the present invention;

FIG. 20 is a table showing pattern contents of image data depending on output signals of first to third decision units comprised in the data comparator of the present invention;

FIG. 21 is a block diagram illustrating another construction of the basic circuit block comprised in the data comparator comprised in the scan driver of the plasma display apparatus according to the present invention;

FIG. 22 is a table showing pattern contents of image data depending on output signals of first to ninth decision units comprised in the circuit block diagram of FIG. 21 according to the present invention;

FIG. 23 is a block diagram illustrating a data comparator and a scan order decision unit of the scan driver in the plasma display apparatus of the present invention taking FIGS. 21 and 22 into consideration;

FIG. 24 is a block diagram according to an embodiment in which the data comparator and the scan order decision unit- according to the present invention are applied on a sub-field basis;

FIG. 25 is a view illustrating an example of a method of selecting a sub-field for scanning scan electrodes according to any one of a plurality of scan pulse supply orders within one frame;

FIG. 26 is a view illustrating that scan orders can be different from each other in patterns of two different image data;

FIG. 27 is a view illustrating an exemplary method of controlling a scan order by setting a critical value depending on an image data pattern; and

FIG. 28 is a view illustrating an example of a method of deciding a scan order corresponding to scan electrode groups, each comprising a plurality of scan electrodes.

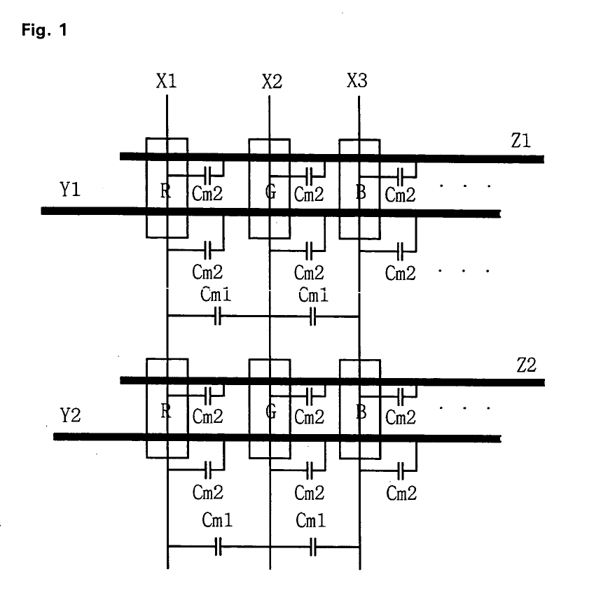

### DETAILED DESCRIPTION OF PREFERRED EMBODIMENTS

Embodiments of the present invention will be described in a more detailed manner with reference to the drawings.

A plasma display apparatus according to an aspect of the present invention comprises a plurality of scan electrodes, a plurality of data electrodes intersecting the scan electrodes, a scan driver for supplying scan pulses to the plurality of scan electrodes according to any one of two or more different scan pulse supply orders, and a data driver for supplying at least one data pulse, which corresponds to one scan pulse and has an application time point different from an application time point of the scan pulse, to the data electrodes.

The scan driver supplies the scan pulse according to the scan pulse supply order in which a displacement current of incoming image data is the lowest.

The scan electrodes comprise a first scan electrode and a second scan electrode, and the data electrodes comprise a first data electrode and a second data electrode. A first discharge cell and a second discharge cell are disposed at the intersections of the first scan electrode and the first and the second data electrodes. Third and fourth discharge cells are disposed at the intersections of the second scan electrode and the first and the second data electrodes. The scan driver calculates a displacement current for the first discharge cell by comparing data of the first to fourth discharge cells.

The scan driver obtains a first result of comparing data of the first discharge cell and data of the second discharge cell, a second result of comparing the data of the first discharge cell and data of the third discharge cell, and a third result of comparing the data of the third discharge cell and data of the fourth discharge cell, decides a calculation equation of the displacement current through a combination of the first to third results, and calculates a total displacement current of the first discharge cell by summing the displacement currents calculated using the decided calculation equation.

Assuming that a capacitance between the adjacent data electrodes equals Cm1, and a capacitance between the data electrode and the scan electrode and a capacitance between the data electrode and the sustain electrode equals Cm2, the scan driver calculates the displacement current according to a combination of the first to third results based on Cm1 and Cm2.

The scan driver calculates the displacement current of each sub-field of one frame, and supplies the scan pulse according to the scan pulse supply order in which the displacement current is the lowest each sub-field.

The scan pulse supply order comprises a first scan pulse supply order in which a scan pulse is supplied to the scan electrodes with them being divided into a plurality of groups. The scan driver consecutively supplies the scan pulse to scan electrodes belonging to the same scan electrode group in the case where a scan pulse supply order in which the displacement current is the lowest is the first scan pulse supply order.

The scan driver calculates a displacement current corresponding to each of the plurality of scan pulse supply orders according to incoming image data, and supplies the scan pulse to the scan electrodes according to at least one of scan pulse supply orders in which the displacement current is lower than a preset critical displacement current, of the plurality of scan pulse supply orders.

The plurality of data electrodes is divided into two or more data electrode groups. The data electrode groups comprise one or more data electrodes.

The data electrode groups comprise the same number of data electrodes or a different number of data electrodes.

The data driver supplies the data pulse to all of the data electrodes comprised in one data electrode group at the same application time point.

The data driver sets a difference in an application time point between two or more data pulses corresponding to the one scan pulse to be the same or different.

The data driver sets a difference in an application time point between two or more data pulses corresponding to the one scan pulse to range from 10 ns to 1000 ns.

The data driver sets a difference in an application time point between two or more data pulses corresponding to the one scan pulse to have a value ranging from 1/100 to 1 times of a predetermined scan pulse width.

A plasma display apparatus according to another aspect of the present invention comprises a plasma display panel in which a plurality of scan electrodes and a plurality of data electrodes intersecting the scan electrodes are formed, a scan driver for supplying a scan pulse to the scan electrodes by setting a scan order of the plurality of scan electrodes in a second data pattern different from a first data pattern of data patterns of incoming image data to be different from the scan order of the first data pattern, and a data driver for supplying at least one data pulse, which corresponds to one scan pulse and has an application time point different from an application time point of the scan pulse, to the data electrodes.

Any one of a data load value of the first data pattern and a data load value of the second data pattern is more than a preset critical load value.

A data load value depending on the data pattern is obtained by the sum of a data load value in a horizontal direction of a data pattern and a data load value in a vertical direction of the data pattern.

Any one of a displacement current of the first data pattern and a displacement current of the second data pattern is more than a preset critical current.

A method of driving a plasma display apparatus comprising a plurality of scan electrodes and a plurality of data electrodes intersecting the scan electrodes according to another aspect of the present invention comprises the steps of supplying scan pulses to the plurality of scan electrodes according to any one of two or more different scan pulse supply orders, and supplying at least one data pulse, which corresponds to one scan pulse and has an application time point different from an application time point of the scan pulse, to the data electrodes.

A method of driving a plasma display apparatus comprising a plurality of scan electrodes and a plurality of data electrodes intersecting the scan electrodes according to another aspect of the present invention comprises the steps of supplying a scan pulse to the scan electrodes by setting a scan order of the plurality of scan electrodes in a second data pattern different from a first data pattern of data patterns of incoming image data to be different from the scan order of the first data pattern, and supplying at least one data pulse, which corresponds to one scan pulse and has an application time point different from an application time point of the scan pulse, to the data electrodes.

A plasma display apparatus and driving method thereof according to an embodiment of the present invention will now be described with reference to the accompanying drawings.

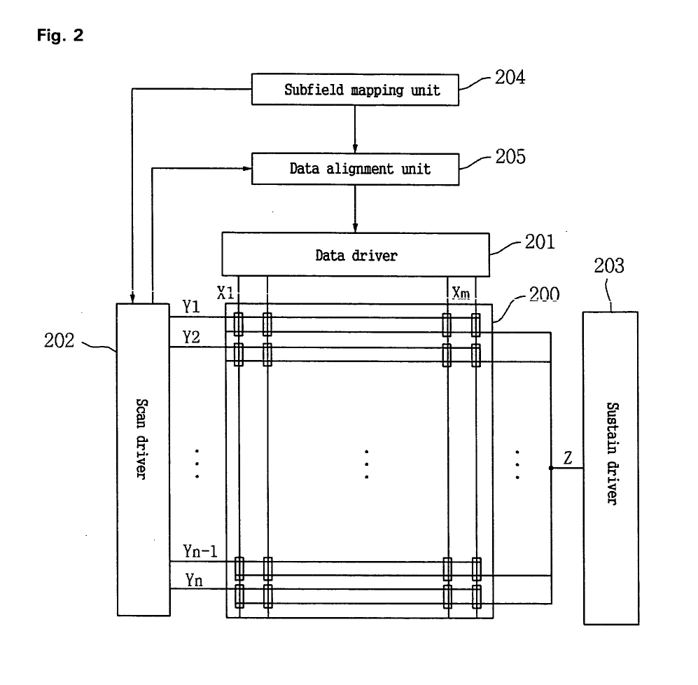

FIG. 2 is a block diagram of a plasma display apparatus according to the present invention.

Referring to FIG. 2, the plasma display apparatus of the present invention comprises a plasma display panel 200, a data driver 201, a scan driver 202, a sustain driver 203, a sub-field mapping unit 204 and a data arrangement unit 205.

The plasma display panel 200 has a front panel (not shown) and a rear panel (not shown), which are coalesced together with a predetermined distance therebetween. A plurality of electrodes, such as scan electrodes Y and a sustain electrode Z parallel to the scan electrodes Y, is formed in the plasma display panel 200. Data electrodes X intersecting the scan electrodes Y and the sustain electrode Z are also formed in the plasma display panel 200.

The scan driver 202 supplies a ramp-up waveform (Ramp-up) and a ramp-down waveform (Ramp-down) to the scan electrodes Y during a reset period. The scan driver 202 also supplies a sustain pulse (SUS) to the scan electrodes Y during the sustain period. More particularly, the scan driver 202 scans the scan electrodes Y according to one of a plurality of scan pulse supply orders in which the order of supplying scan pulses to the plurality of scan electrodes Y in the address period is different. In other words, the scan driver 202 supplies a scan pulse (Sp) of a negative scan voltage (−Vy) to the scan electrodes Y during the address period according to one of the plurality of scan pulse supply orders.

The sustain driver 203 supplies the sustain pulse (SUS) to the sustain electrode Z while operating alternately with the scan driver 202 during the sustain period, and provides a predetermined bias voltage (Vzb) to the sustain electrode Z in the address period and a set-down period.

The sub-field mapping unit 204 sub-field-maps image data, which are supplied from the outside, e.g., from a halftone correction unit, and then outputs the sub-field mapped data.

The data arrangement unit 205 rearranges the data that have been sub-field-mapped by the sub-field mapping unit 204 so that the data correspond to each of the data electrodes X of the plasma display panel 200.

The data driver 201 samples and latches the data that have been rearranged by the data arrangement unit 205 under the control of a timing controller (not shown), and provides the resulting data to the data electrodes X. More particularly, the data driver 201 supplies the data to the data electrodes X corresponding to a scan pulse supply order in which the scan driver 202 scans the scan electrodes Y. The data driver 201 supplies data to the data electrodes corresponding to one scan pulse supply order, but supplies data pulses to one or more of the plurality of data electrodes at an application time point different from an application time point of a scan pulse applied to the scan electrodes by the scan driver 202.

Function, operation and characteristics of each of constituent elements of the plasma display apparatus constructed above according to the present invention will become clear through description of a method of driving the plasma display apparatus according to the present invention later on.

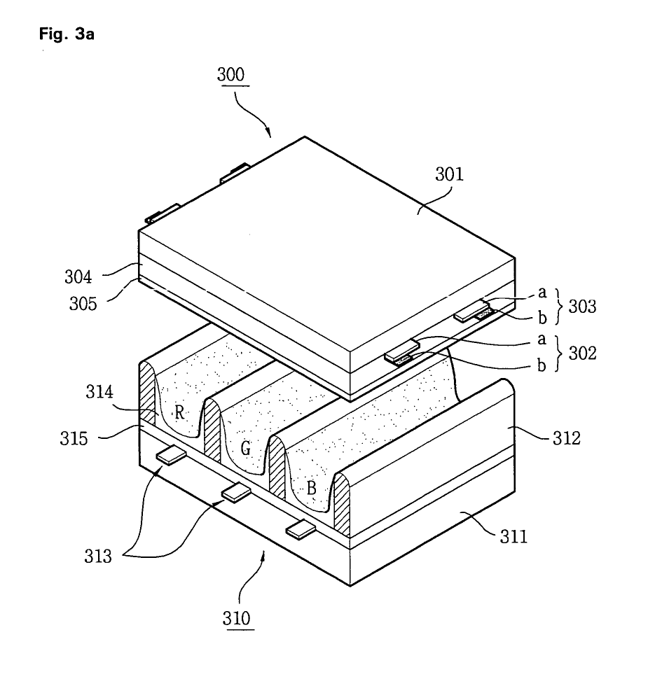

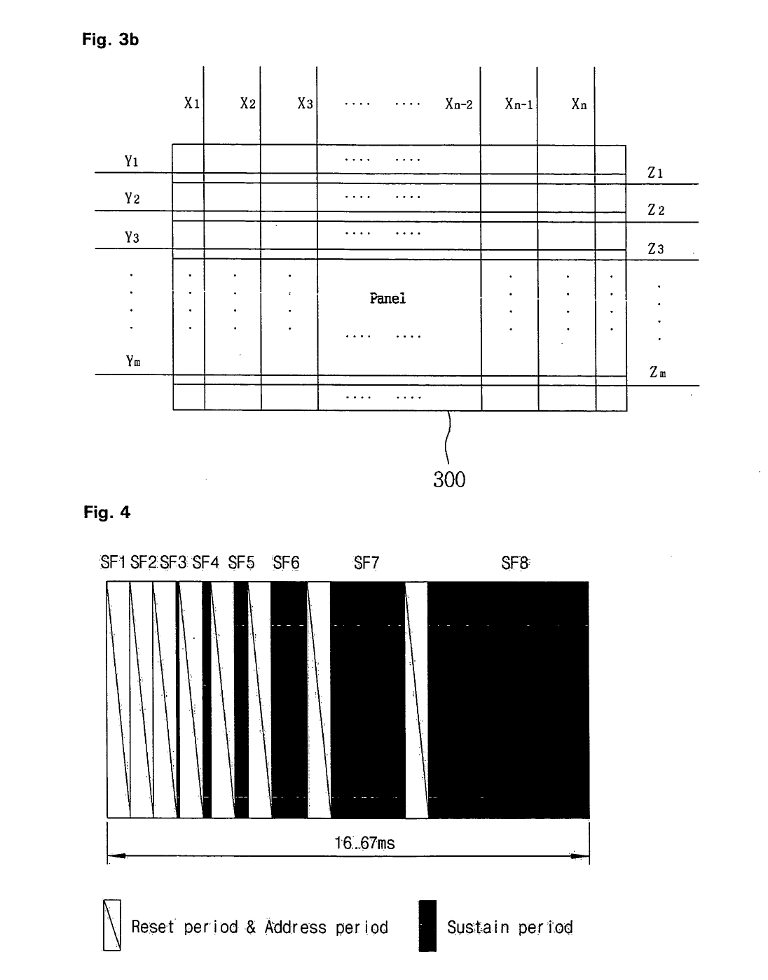

An example of the plasma display panel 200, i.e., one of the constituent elements of the plasma display apparatus of the present invention will now be described in more detail with reference to FIGS. 3a and 3b.

FIGS. 3a and 3b are views illustrating an exemplary structure of a plasma display panel according to the present invention.

As shown in FIG. 3a, the plasma display panel comprises a front panel 300 and a rear panel 310. In the front panel 300, a plurality of sustain electrodes in which a scan electrode 302, Y and a sustain electrode 303, Z are formed in pairs is arranged on a front substrate 301 serving as a display surface on which images are displayed. In the rear panel 310, a plurality of data electrodes 313, X intersecting the plurality of sustain electrodes is arranged on a rear substrate 311 serving as a rear surface. The front panel 300 and the rear panel 310 are coalesced in parallel with a predetermined distance therebetween.

The front panel 300 comprises pairs of the scan electrode 302, Y and the sustain electrode 303, Z, which mutually discharge and maintain the emission of a cell within one discharge cell. In other words, each of the scan electrode 302, Y and the sustain electrode 303, Z comprises a transparent electrode (a) formed of a transparent ITO material and a bus electrode (b) formed of a metal material. The scan electrode 302, Y and the sustain electrodes 303 Z are covered with one or more dielectric layers 304 for limiting a discharge current and providing insulation among the electrode pairs. A protection layer 305 having deposited Magnesium Oxide (MgO) thereon is formed on the dielectric layers 304 in order to facilitate discharge conditions.

In the rear panel 310, barrier ribs 312 of a stripe form (or a well form), for forming a plurality of discharge spaces, i.e., discharge cells are arranged in parallel. Furthermore, the plurality of data electrodes 313, X, which perform an address discharge to generate vacuum ultraviolet rays, is disposed parallel to the barrier ribs 312. R, G and B phosphor 314 that radiate a visible ray for displaying an image during the address discharge are coated on a top surface of the rear panel 310. A lower dielectric layer 315 for protecting the data electrodes 313, X is formed between the data electrodes 313, X and the phosphors 314.

FIG. 3a shows only an exemplary structure of the plasma display panel, i.e., one of driving elements of the plasma display apparatus according to the present invention. However, the present invention is not limited to the structure of FIG. 3a. Furthermore, it has been shown in FIG. 3a that the scan electrode 302 Y and the sustain electrode 303, Z are formed in the front panel 300 and the data electrodes 313, X are formed in the rear panel 310. However, the scan electrode 302 Y, the sustain electrode 303 Z and the data electrodes 313 X can be formed in the front panel 300.

It has also been shown in FIG. 3a that each of the scan electrode 302, Y and the sustain electrode 303, Z comprises the transparent electrode (a) and the bus electrode (b). Unlike the above, however, one or more of the scan electrode 302, Y and the sustain electrode 303, Z can comprise only the bus electrode (b).

In the plasma display panel constructed as shown in FIG. 3a, the arrangement structure of the electrodes is shown in FIG. 3b.

Referring to FIG. 3b, in the plasma display panel 300, the scan electrodes Y and the sustain electrodes Z are parallel to each other. The data electrodes X cross the scan electrodes Y and the sustain electrodes Z. Drivers are connected to the electrodes.

The plasma display apparatus of the present invention, including the plasma display panel, implements gray levels of various images with a frame being divided into a plurality of sub-fields. A method of implementing gray levels in the plasma display apparatus of the present invention will be described below with reference to FIG. 4.

FIG. 4 is a view illustrating a method of implementing gray levels of an image in a plasma display apparatus according to the present invention.

Referring to FIG. 4, in the method of implementing gray levels of an image in the plasma display apparatus of the present invention, one frame is divided into several sub-fields having a different number of emissions. Each of the sub-fields is divided into a reset period (RPD) for initializing the entire cells, an address period (APD) for selecting a discharge cell to be discharged and a sustain period (SPD) for implementing gray levels depending on a discharge number.

For example, if it is sought to display images with 256 gray levels, a frame period (16.67 ms) corresponding to 1/60 seconds is divided into eight sub-fields (SF1 to SF8) as shown in FIG. 4. Each of the eight sub-fields (SF1 to SF8) is again divided into a reset period, an address period and a sustain period.

The sustain period is a period where a gray level weight in each sub-field is decided. For example, a gray level weight of each sub-field can be decided such that is increased in the ratio of 2ⁿ (where n=0, 1, 2, 3, 4, 5, 6, 7) in such a manner that a gray level weight of a first sub-field is set to 2⁰ and a gray level weight of a second sub-field is set to 2¹. Gray levels of various images can be implemented by controlling the number of sustain pulses provided in a sustain period of each of sub-fields according to a gray level weight in the sustain period in each sub-field, as described above.

A case where one frame has eight sub-fields has been described in FIG. 4. However, the number of sub-fields constituting one frame can be varied in various manners. For example, one frame can has twelve sub-fields from a first sub-field to a twelfth sub-field. Ten sub-fields can also constitute one frame.

It has also been shown in FIG. 4 that sub-fields are arranged in order in which amounts of gray level weights increase in one frame. Unlike the above, however, sub-fields can be arranged in order in which amounts of gray level weights decrease in one frame, or can be arranged regardless of their gray level weights.

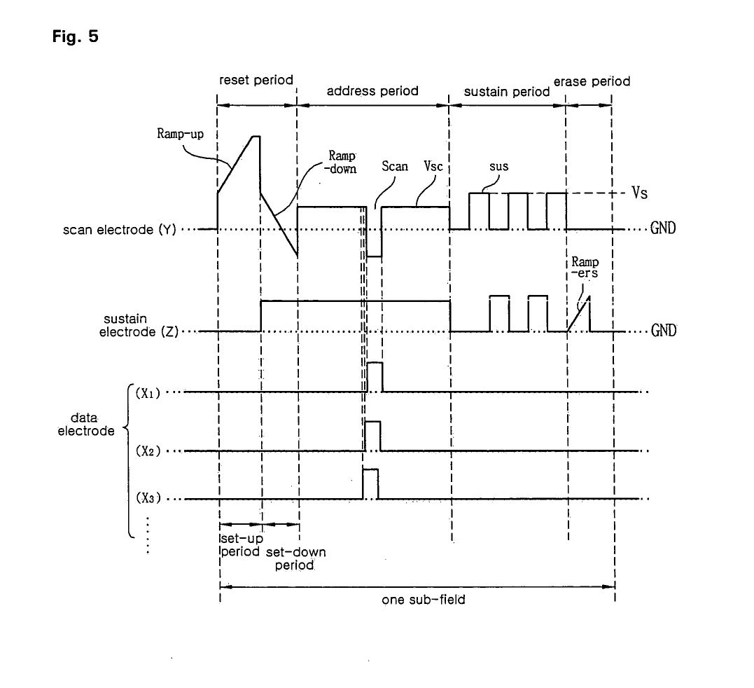

FIG. 5 is a view illustrating a method of driving a plasma display apparatus according to the present invention.

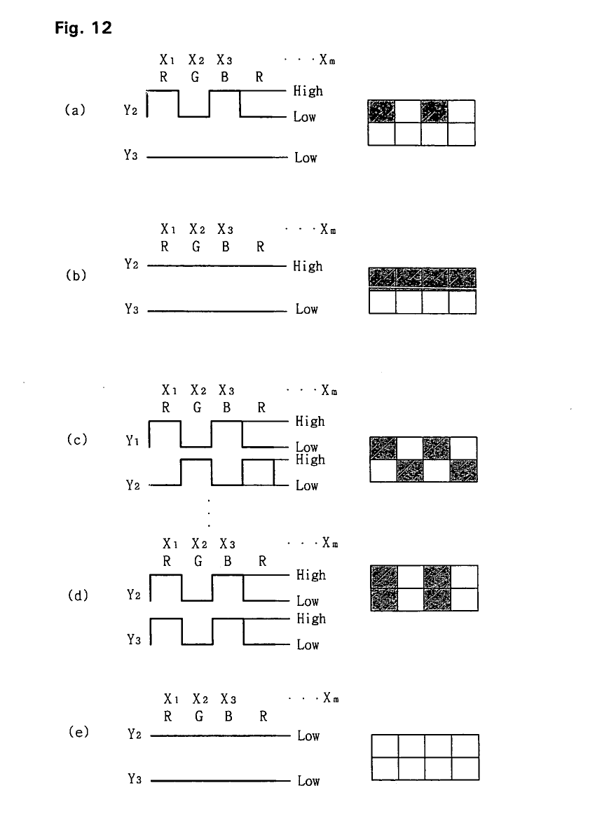

Referring first to FIG. 5, in the method of driving the plasma display apparatus of the present invention, in the address period of at least one sub-field, one or more of a plurality of data electrodes X are supplied with data pulses at an application time point different from an application time point of a scan pulse applied to the scan electrodes Y. Furthermore, though not shown in FIG. 5, the method of driving the plasma display apparatus according to the present invention can also include scanning the scan electrodes Y according to one of plurality of scan pulse supply orders in which an order of supplying the scan pulses to the plurality of scan electrodes Y in the address period is different. This will be described in detail with reference to FIG. 12 later on.

In a set-up period of the reset period, a ramp-up waveform (Ramp-up) is applied to the scan electrode Y. The ramp-up waveform generates a weak dark discharge within discharge cells of the entire screen. The set-up discharge causes positive wall charges to be accumulated on the data electrode X and the sustain electrode Z and negative wall charges to be accumulated on the scan electrode Y.

After the ramp-up waveform is supplied to the scan electrode Y, in a set-down period of the reset period, a ramp-down waveform (Ramp-down), which starts to fall from a positive voltage lower than a peak voltage of the ramp-up waveform to a predetermined voltage level lower than a ground (GND) level voltage, generates a weak erase discharge within the discharge cells, thus sufficiently erasing wall charges that have been excessively formed within the discharge cells. The set-down discharge causes wall charges of the degree in which an address discharge can be stably generated to uniformly remain within the discharge cells.

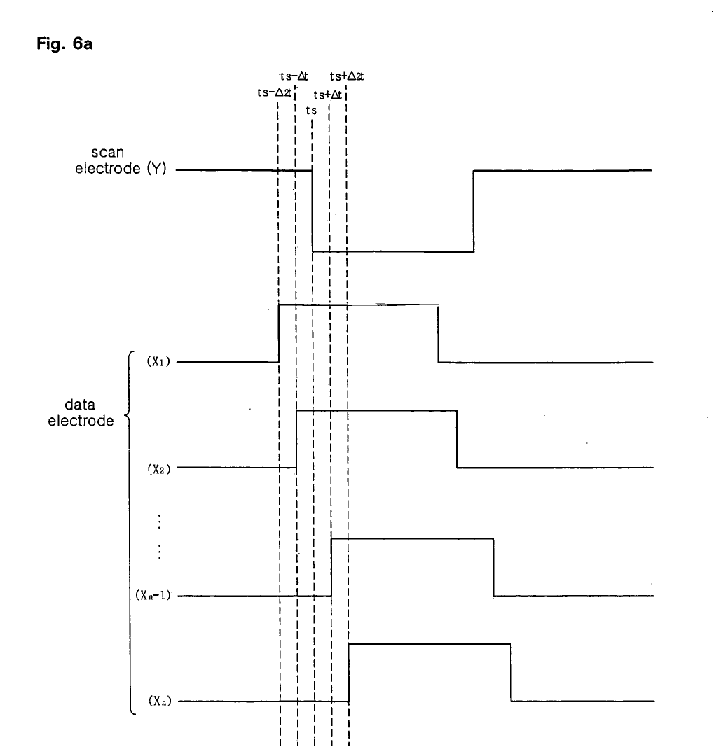

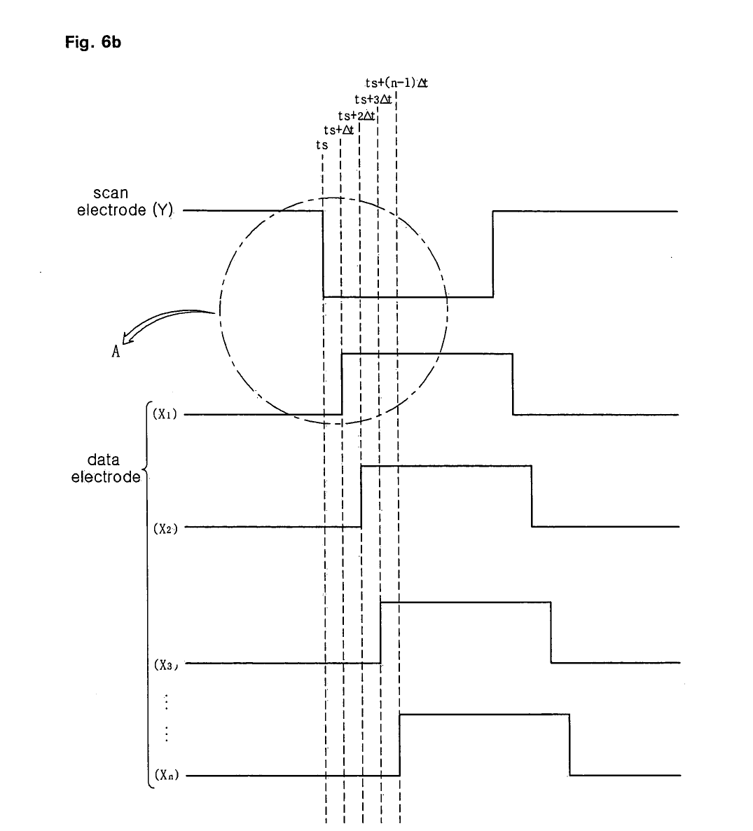

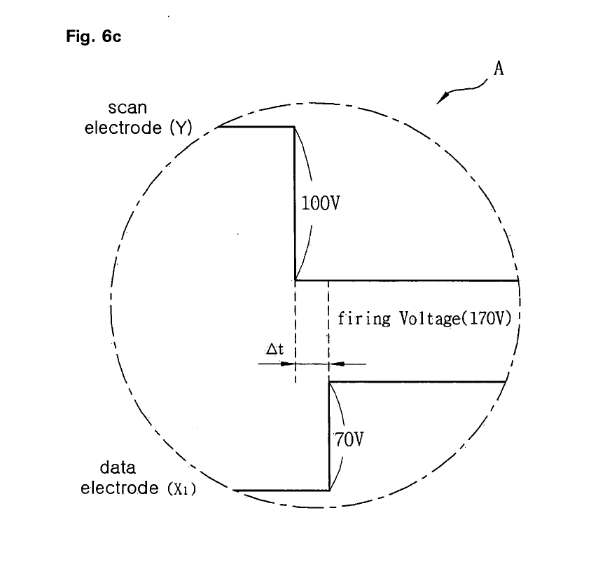

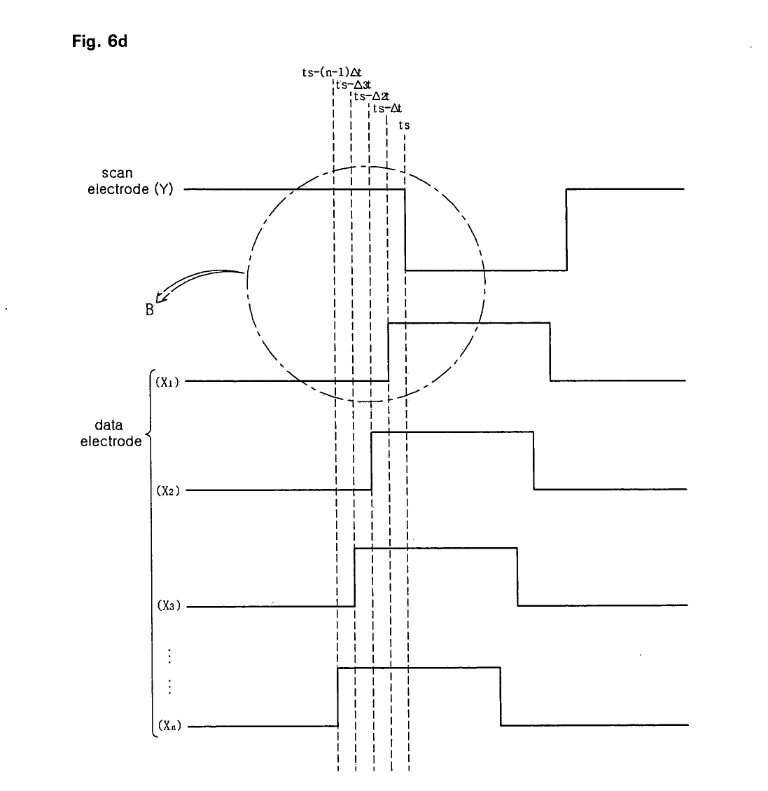

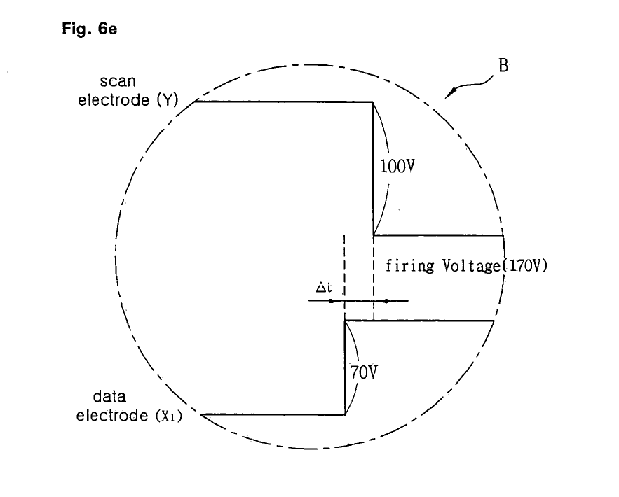

In the address period, while a negative scan pulse falling from a scan reference voltage (Vsc) is applied to the scan electrode Y, a positive data pulse is applied to the data electrode X in synchronization with the scan pulse. At this time, at an application time point different from an application time point of the scan pulse applied to the scan electrode Y, the data pulse is applied to the data electrode X. The reason why an application time point of the scan pulse and an application time point of the data pulse in the address period are different from each other as described above will be described blow in more detail with reference to FIG. 6.

As a voltage difference between the scan pulse and the data pulse and a wall voltage generated in the reset period are added, an address discharge is generated within discharge cells to which the data pulse is applied. Furthermore, wall charges of the degree in which a discharge can be generated when a sustain voltage (Vs) is applied are formed within discharge cells selected by the address discharge.

In the sustain period, sustain pulses (Sus) are alternately applied to one or more of the scan electrode Y and the sustain electrode Z. As a wall voltage within discharge cells and the sustain pulse are added, a sustain discharge, i.e., a display discharge is generated between the scan electrode Y and the sustain electrode Z in discharge cells selected by the address discharge whenever the sustain pulses are applied.

In addition, after the sustain discharge is completed, a voltage of an erase ramp waveform (Ramp-ers) having a narrow pulse width and a low voltage level is applied to the sustain electrode Z in the erase period, thereby erasing wall charges remaining within the discharge cells of the entire screen.

FIGS. 6a to 6e are timing diagrams showing an example of a method of applying a data pulse to each data electrode at a different time point from an application time point of a scan pulse in the method of driving the plasma display apparatus according to the present invention.

As shown in FIGS. 6a to 6e, in the method of driving the plasma display apparatus of the present invention, applying time points of a scan pulse and a data pulse are set to be different from each other. In an address period of one sub-field, an application time point of the data pulse applied to the data electrodes X is set to be different from an application time point of the scan pulse applied to the scan electrode Y.

As shown in FIG. 6a, in the method of driving the plasma display apparatus of the present invention, assuming that an application time point of the scan pulse applied to the scan electrode Y is ts, according to an arrangement order of data electrodes X₁ to Xn, the data pulse is applied to the data electrode X₁ at an application time point, which is 2Δt earlier than an application time point where the scan pulse is applied to the scan electrode Y, i.e., at an application time point ts−2Δt. Furthermore, the scan pulse is applied to the data electrode X₂ at an application time point, which is Δt earlier than an application time point where the scan pulse is applied to the scan electrode Y, i.e., at an application time point ts−Δt. In this manner, the electrode X(n−1) is supplied with the data pulse at an application time point ts+Δt, and the electrode Xn is supplied with the data pulse at an application time point ts+2Δt. That is, as shown in FIG. 6a, the data pulse applied to the data electrodes X₁ to Xn is applied earlier than or later than the applying time points of the scan pulses applied to the scan electrodes Y.

As shown in FIG. 6b, in the driving waveform according to the driving method of the plasma display apparatus of the present invention, assuming that an application time point of the scan pulse applied to the scan electrode Y is ts, according to an arrangement order of data electrodes X₁ to Xn, the data pulse is applied to the data electrode X₁ at an application time point, which is Δt later than an application time point where the scan pulse is applied to the scan electrode Y, i.e., at an application time point ts+Δt. Furthermore, the scan pulse is applied to the data electrode X₂ at an application time point, which is 2Δt later than an application time point where the scan pulse is applied to the scan electrode Y, i.e., at an application time point ts+2Δt. In this manner, the electrode X₃ is supplied with the data pulse at an application time point ts+3Δt, and the electrode Xn is supplied with the data pulse at an application time point ts+(n−1)Δt. That is, as shown in FIG. 6b, the data pulses applied to the data electrodes X₁ to Xn are applied later than the applying time points of the scan pulses applied to the scan electrodes Y.

A region A where a discharge in the driving waveform of FIG. 6b is generated will be described with reference to FIG. 6c. For example, it is assumed that an address discharge firing voltage is 170V, a voltage of the scan pulse is 100V and a voltage of the data pulse is 70V. In this case, in the region A, a voltage difference between the scan electrode Y and the data electrode X₁ becomes 100V due to the scan pulse applied to the scan electrode Y, and a voltage difference between the scan electrode Y and the data electrode X₁ rises up to 170V due to the data pulse applied to the data electrode X₁ after Δt elapses since the scan pulse is applied. Therefore, since the voltage difference between the scan electrode Y and the data electrode X₁ becomes an address discharge firing voltage, an address discharge is generated between the scan electrode Y and the data electrode X₁.

As shown in FIG. 6d, in the driving waveform according to the driving method of the plasma display apparatus of the present invention, assuming that an application time point of the scan pulse applied to the scan electrode Y is ts, according to an arrangement order of data electrodes X₁ to Xn, the data pulse is applied to the data electrode X₁ at an application time point, which is Δt earlier than an application time point where the scan pulse is applied to the scan electrode Y, i.e., at an application time point ts−Δt. Furthermore, the scan pulse is applied to the date electrode X₂ at an application time point, which is 2Δt earlier than an application time point where the scan pulse is applied to the scan electrode Y, i.e., at an application time point ts−2Δt. In this manner, the electrode X₃ is supplied with the data pulse at an application time point ts−3Δt, and the electrode Xn is supplied with the data pulse at an application time point ts−(n−1)Δt. That is, as shown in FIG. 6d, the data pulses applied to the data electrodes X₁ to Xn are applied earlier than the applying time points of the scan pulses applied to the scan electrodes Y.

A region B where a discharge in the driving waveform of FIG. 6d is generated will be described with reference to FIG. 6e. For example, it is assumed that an address discharge firing voltage is 170V, a voltage of the scan pulse is 100V and a voltage of the data pulse is 70V as shown in FIG. 6c. In this case, in the region B, a voltage difference between the scan electrode Y and the data electrode X₁ becomes 70V due to the data pulse applied to the electrode X₁, and a voltage difference between the scan electrode Y and the data electrodes X₁ to Xn rises up to 170V due to the scan pulse applied to the scan electrode Y after Δt elapses since the data pulse is applied. Therefore, since the voltage difference between the scan electrode Y and the data electrode X₁ becomes an address discharge firing voltage, an address discharge is generated between the scan electrode Y and the data electrode X₁.

In FIGS. 6a to 6e, a difference between an application time point of the scan pulse applied to the scan electrode Y and an application time point of the data pulse applied to the data electrodes X₁ to Xn, or a difference between applying time points of the data pulses applied to the data electrodes X₁ to Xn has been described in terms of the concept of Δt.

At will now be described. For example, it is assumed that an application time point of the scan pulse applied to the scan electrode Y is ts, a time difference in an application time point between data pulses, which are the closest to the applying time point ts of the scan pulse is Δt, and a difference in an application time point between the applying time point ts of the scan pulse and a next data pulse is twice Δt, i.e., 2Δt, wherein Δt keeps constant. That is, while the applying time points of the scan pulses applied to the scan electrodes Y and the applying time point of the data pulse applied to the data electrodes X₁ to Xn are set to be different from each other, a difference in the applying time point between the data pulses applied to the data electrodes X₁ to Xn is set to be the same. In this case, a difference in the applying time point between the data pulses applied to the data electrodes X₁ to Xn within one sub-field can be set to be the same, but a difference between an application time point of the scan pulse and applying time points of data pulses, which are the closest to the applying time point of the scan pulse, can be set to be the same or different from each other.

For example, assuming that while a difference between applying time points of data pulses applied to the data electrodes X₁ to Xn within one sub-field is set to be the same, a difference between the applying time point ts of the scan pulse and an application time point of a data pulse, which is the closest to the applying time point ts of the scan pulse, in any one address period is Δt, a time difference between the applying time point ts of the scan pulse and an application time point of a data pulse, which is the closest to the applying time point ts of the scan pulse, can be set to 2Δt in other address periods in the same sub-field.

In this case, a time difference between the applying time point ts of the scan pulse and the applying time point of the data pulse, which is the closest to the applying time point ts of the scan pulse can be set to range from 10 ns to 1000 ns when considering a limited time of the address period. Furthermore, from a viewpoint of any one scan pulse width depending on the driving of the plasma display panel, Δt can be set within a range of 1/100 to 1 times of a predetermined scan pulse width. For example, assuming that a width of one scan pulse is 1 μs, the time difference between the applying time points can have 1/100 of 1 μs, i.e. from 10 ns to one times of 1 μs, i.e., within a range of 1000 ns or less.

Furthermore, while an application time point of the scan pulse and an application time point of the data pulse are set to be different from each other as described above, a time difference in an application time point between the data pulses can also be set to be different from each other. That is, while applying time points of the data pulses applied to the data electrodes X₁ to Xn are set to be different from an application time point of the scan pulse applied to the scan electrode Y, applying time points of the data pulses applied to the data electrodes X₁ to Xn can be set to be different from each other.

For example, assuming that an application time point of the scan pulse applied to the scan electrode Y is ts and a time difference in an application time point between data pulses, which are the closest to the applying time point ts of the scan pulse is Δt, a difference between the applying time point ts of the scan pulse and an application time point of a data pulse, which is next to the applying time point ts of the scan pulse, can be se to 3Δt. For example, assuming that an application time point where the scan pulse is applied to the scan electrode Y is 0 ns, the data pulse is applied to the data electrode X₁ at an application time point of 10 ns. Therefore, a time difference between the applying time points of the scan pulses applied to the scan electrodes Y and the applying time point of the data pulse applied to the data electrode X₁ is 10 ns. Furthermore, a data pulse is applied to a next data electrode X₂ at an application time point of 20 ns. Therefore, a time difference between the applying time points of the scan pulses applied to the scan electrodes Y and the applying time point of the data pulse applied to the data electrode X₂ is 20 ns. As a result, a time difference between the applying time point of the scan pulse applied to the data electrode X₁ and the applying time point of the data pulse applied to the data electrode X₂ is 10 ns. In addition, a data pulse is applied to a next data electrode X₃ at an application time point of 40 ns. Therefore, a time difference between the applying time points of the scan pulses applied to the scan electrodes Y and the applying time point of the data pulse applied to the data electrode X₃ is 40 ns. As a result, a time difference between the applying time point of the scan pulse applied to the data electrode X₂ and the applying time point of the data pulse applied to the data electrode X₃ is 20 ns. That is, while the applying time points of the scan pulses applied to the scan electrodes Y are set to be different from the applying time points of the data pulses applied to the data electrodes X₁ to Xn, a difference in the applying time point between the data pulses applied to the data electrodes X₁ to Xn can be set to be different.

In this case, a time difference Δt between the applying time points of the scan pulses applied to the scan electrodes Y and the applying time point of the data pulse applied to the data electrodes X₁ to Xn can be set to range from 10 ns to 1000 ns. Furthermore, from a viewpoint of a predetermined scan pulse width depending on the driving of the plasma display panel, Δt can be set within a range of 1/100 to 1 times of the predetermined scan pulse width.

If an application time point of the scan pulse applied to the scan electrode Y is set to be different from applying time points of the data pulses applied to the data electrodes X₁ to Xn in the address period as described above, coupling through capacitance of the panel can be reduced at each of the applying time points of the data pulses applied to the data electrodes X₁ to Xn. It is thus possible to reduce noise of waveforms applied to the scan electrodes and the sustain electrodes.

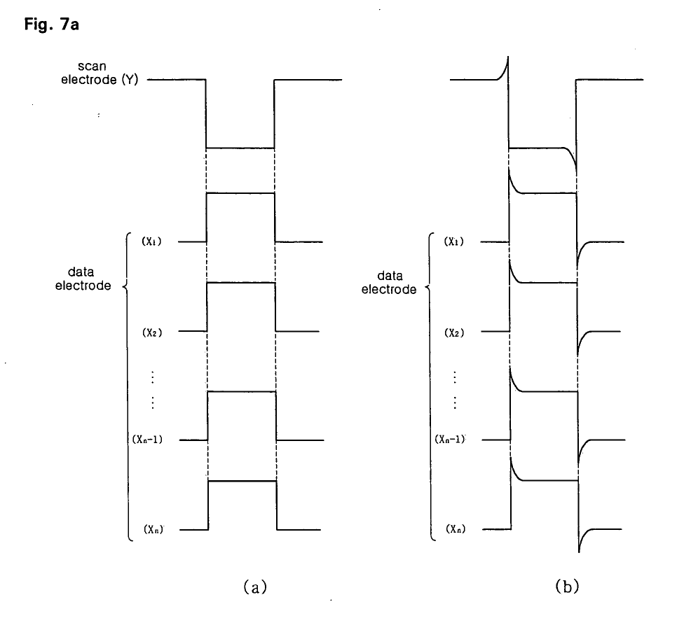

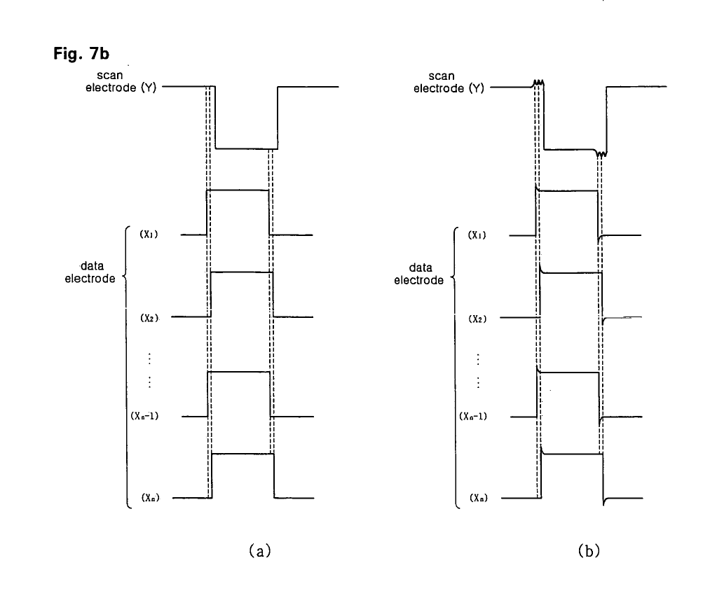

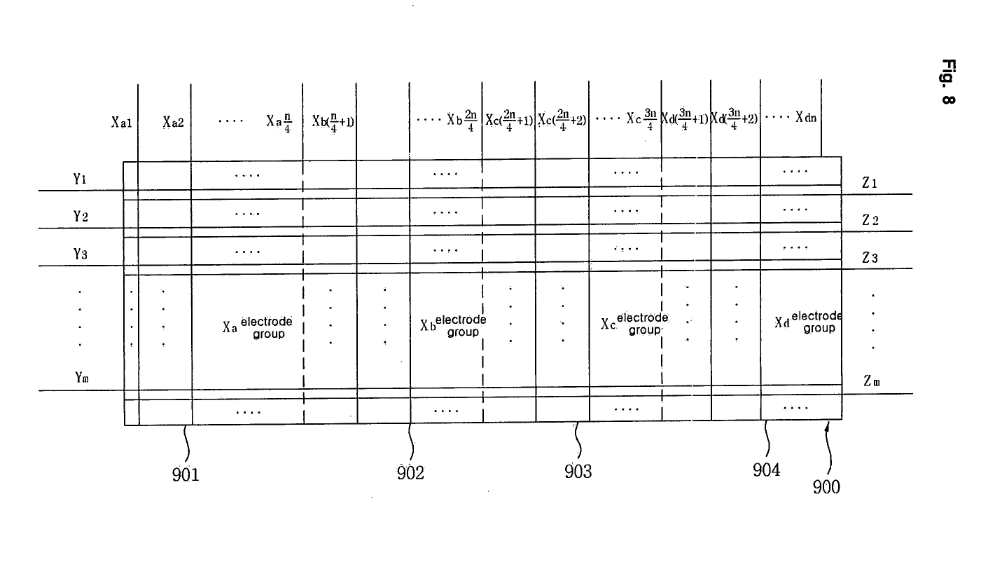

FIGS. 7a and 7b are views illustrating noise reduced by a driving waveform according to the driving method of the present invention.

As shown in FIG. 7a, there will be a case where an application time point of the scan pulse applied to the scan electrode Y and an application time point of the data pulse applied to the data electrodes X in the address period are the same.

As shown in (a) of FIG. 7a, if an application time point of the scan pulse applied to the scan electrode Y and an application time point of the data pulse applied to the data electrodes X in the address period are set to be the same, ts, relatively high noise is generated in a waveform applied to the scan electrode Y and a waveform applied to the sustain electrode Z as in (b). The noise is caused due to coupling through capacitance of a panel. At an application time point where the data pulse abruptly rises, rising noise is generated in waveforms applied to the scan electrode Y and the sustain electrode Z. At an application time point where the data pulse abruptly falls, falling noise is generated in waveforms applied to the scan electrode Y and the sustain electrode Z.

The noise, which is generated in the waveforms applied to the scan electrode Y and the sustain electrode Z due to the data pulse applied to the data electrodes X in synchronization with the scan pulse applied to the scan electrode Y as described above, makes unstable an address discharge occurring in the address period. Therefore, a problem arises because driving efficiency of the plasma display panel is decreased.

As shown in FIG. 7b, there is a case where applying time points of the data pulse and the scan pulse are different from each other in the method of driving the plasma display apparatus of the present invention.

That is, as shown in (a) of FIG. 7b, if the data pulses are not applied to the data electrodes X at the same application time point as an application time point of the scan pulse applied to the scan electrode Y, but are applied to the data electrodes X at time points different from the applying time points of the scan pulses applied to the scan electrodes Y, a magnitude of noise can be significantly reduced as shown in (b), in comparison with (b) of FIG. 7a.

This can reduce coupling through capacitance of a panel at an application time point where the data pulse is applied to the data electrodes X. Therefore, at an application time point where the data pulse abruptly rises, rising noise generated in waveforms applied to the scan electrode and the sustain electrode can be reduced. Furthermore, at an application time point where the data pulse abruptly falls, falling noise generated in waveforms applied to the scan electrode and the sustain electrode can be reduced. Accordingly, an address discharge generated in the address period can be stabilized and a reduction in driving stability of the plasma display panel can be prohibited.

As a result, since an address discharge of the plasma display panel is stabilized, a single scan method of scanning the whole panel using one driver can be applied. The term “single scan method” refers to a driving method in which applying time points of scan waveforms applied to a number of scan electrodes formed on a display region of a front substrate are differently driven in each of the number of scan electrodes.

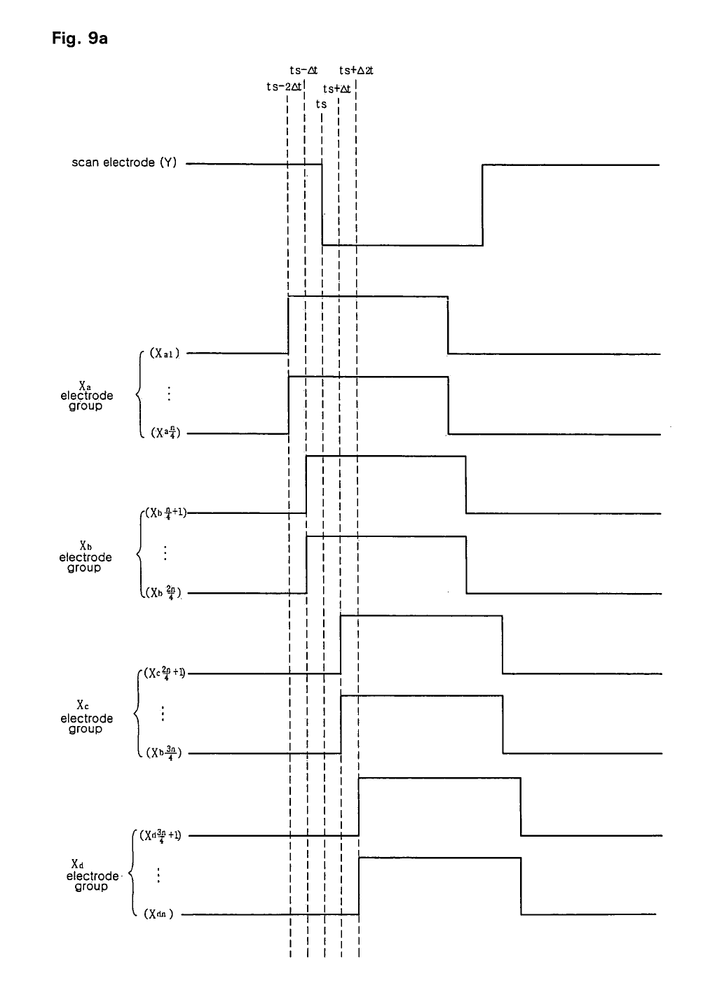

FIG. 8 is a view illustrating that the data electrodes data electrodes X₁ to Xn are divided into four data electrode groups in order to explain another driving method of the plasma display apparatus according to the present invention.

Referring to FIG. 8, in the driving method of present invention in which the plurality of data electrodes X is divided into data electrode groups, each having one or more data electrodes, as shown in FIG. 8, the data electrodes X₁ to Xn of the plasma display panel 900 are divided into, e.g., a Xa electrode group (Xa₁ to Xa(n)/4) 901, a Xb electrode group (Xb((n/4)+1) to Xb(2n)/4) 902, a Xc electrode group (Xc((2n/4)+1) to Xc(3n)/4) 903 and a Xd electrode group (Xd((3n/4)+1) to Xd(n)) 904. At least one of the divided data electrode groups is supplied with the data pulse at an application time point different from an application time point of the scan pulse applied to the scan electrode Y. That is, the electrodes (Xa₁ to Xa(n)/4) belonging to the Xa electrode group 901 are supplied with the data pulses at different time points from the applying time points of the scan pulses applied to the scan electrodes Y, but the applying time points of the data pulses applied to the electrodes (Xa₁ to Xa(n)/4) belonging to the Xa electrode group 901 are the same. Furthermore, the electrodes belonging to the remaining electrode groups 902, 903 and 904 are supplied with the data pulses at time points different from the applying time points of the data pulses applied to the electrodes (Xa₁ to Xa(n)/4) belonging to the Xa electrode group 901. The applying time points of the data pulses applied to the electrodes belonging to the remaining data electrode groups 902, 903 and 904 can be the same as or different from the applying time points of the scan pulses applied to the scan electrodes Y.

Meanwhile, it has been shown in FIG. 8 that the number of the data electrodes included in each of the data electrode groups 901, 902, 903 and 904 is the same. However, the number of data electrodes included in each of the data electrode groups 901, 902, 903 and 904 can be set differently. The number of data electrode groups can also be changed. Furthermore, the number of data electrode groups can be set to range from 2 to a total number of the greatest data electrodes, i.e., 2≦N≦(n−1).

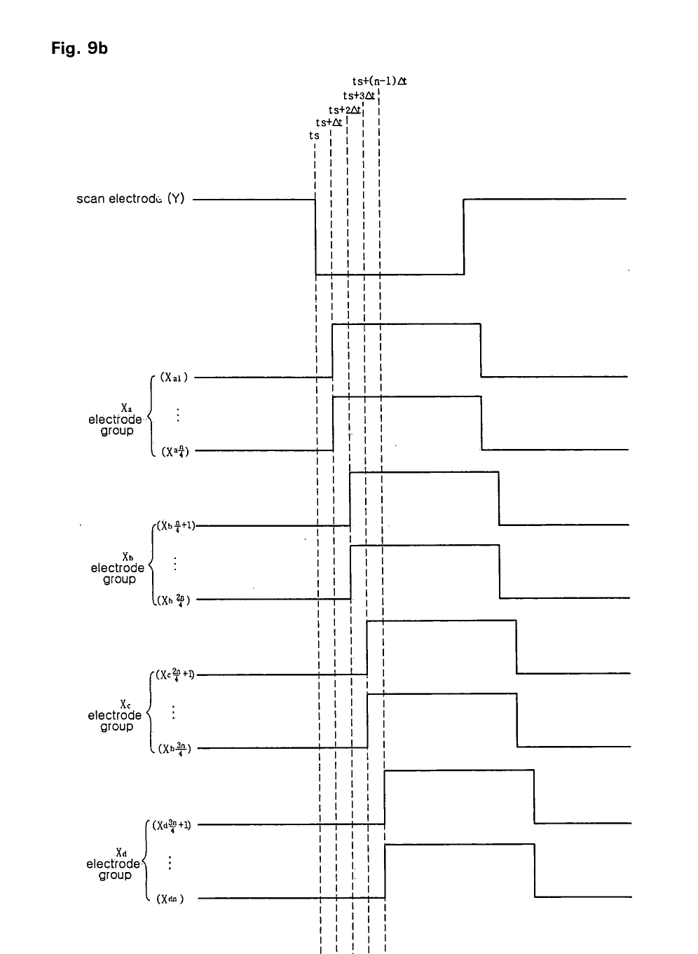

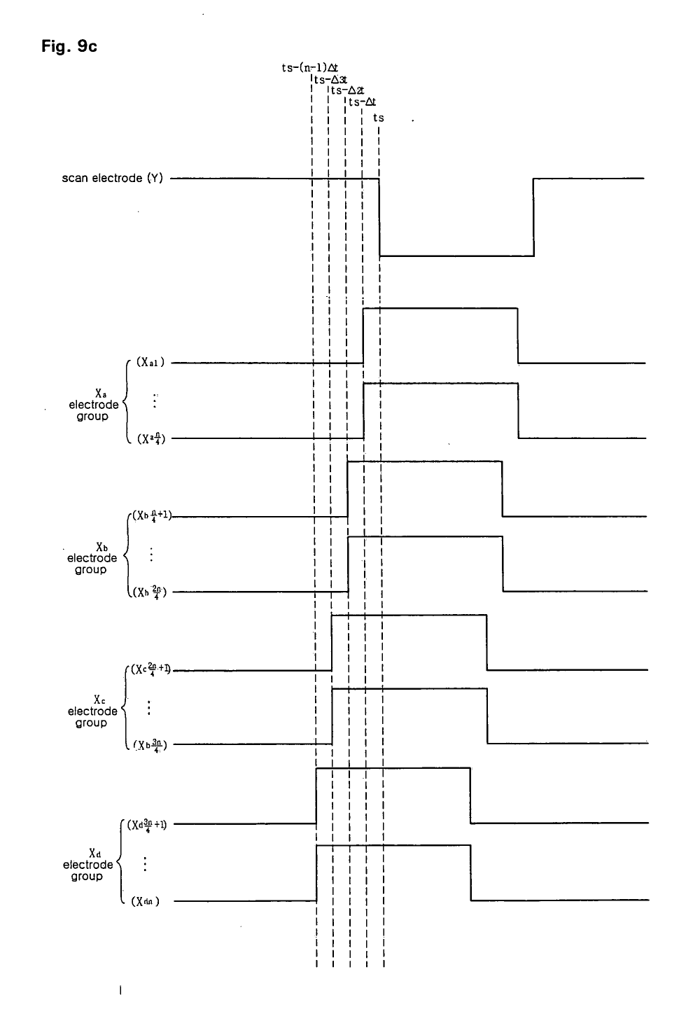

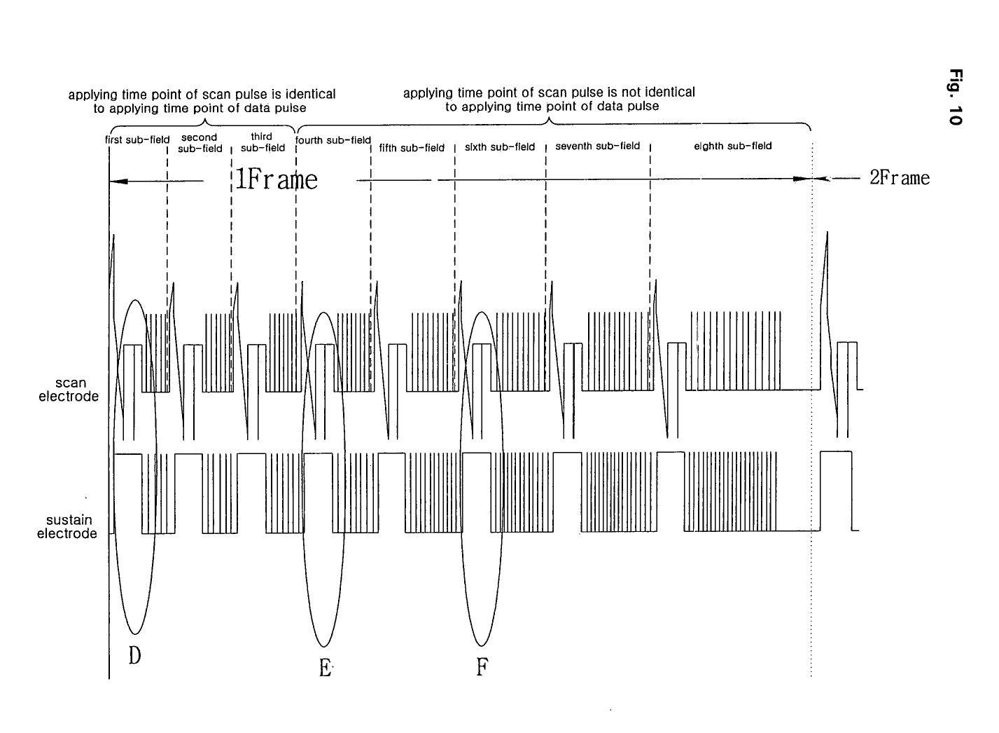

FIGS. 9a to 9c illustrate examples in which the data electrodes data electrodes X₁ to Xn are divided into a plurality of electrode groups and a data pulse is applied to each electrode group at an application time point different from an applying time of the scan pulse in the method of driving the plasma display apparatus according to the present invention.

As shown in FIGS. 9a to 9c, in the driving waveform of the present invention, a plurality of data electrodes X₁ to Xn is divided into a plurality of data electrode groups (a Xa electrode group, a Xb electrode group, a Xc electrode group and a Xd electrode group) in the same manner as FIG. 8. In this state, in an address period of a sub-field, applying time points of data pulses applied to the data electrodes X₁ to Xn of one ore more of the plurality of data electrode groups are different from an application time point of a scan pulse applied to a scan electrode Y. If the applying time points of the scan pulses applied to the scan electrodes Y are set to be different from the applying time points of the data pulses applied to the data electrodes X₁ to Xn as described above, an address discharge can be prevented from becoming unstable and a decrease in driving stability can be prohibited accordingly. This results in enhanced driving efficiency.

For example, as shown in FIG. 9a, in the method of driving the plasma display apparatus according to the present invention, it is assumed that an application time point of a scan pulse applied to the scan electrode Y is ts. According to an arrangement order of data electrode groups having data electrodes X₁ to Xn, data pulses are applied to the data electrodes ((Xa₁ to Xa(n)/4) belonging to the Xa electrode group at an application time point, which is 2Δt earlier than an application time point where the scan pulse is applied to the scan electrode Y, i.e., at an application time point ts−2Δt. Furthermore, the scan pulse is applied to the data electrodes (Xb((n/4)+1) to Xb(2n)/4) belonging to the Xb electrode group at an application time point, which is Δt earlier than an application time point where the scan pulse is applied to the scan electrode Y, i.e., at an application time point ts−Δt. In this manner, the data electrodes (Xc((2n/4)+1) to Xc(3n)/4) belonging to the Xc electrode group are supplied with the data pulses at an application time point ts−Δt, and the data electrodes (Xd((3n/4)+1) to Xd(n)) belonging to the Xd electrode group are supplied with the data pulses at an application time point ts+2Δt. That is, as shown in FIG. 9a, the data pulses applied to the electrode groups Xa, Xb, Xc and Xd, each having the data electrodes X₁ to Xn, are applied earlier than or later than the applying time points of the scan pulses applied to the scan electrodes Y.

As shown in FIG. 9b, in the driving waveform according to the driving method of the plasma display apparatus of the present invention, it is assumed that an application time point of the scan pulse applied to the scan electrode Y is ts. According to an arrangement order of the data electrode groups having the data electrodes X₁ to Xn, the data pulse are applied to the data electrodes included in the electrode group Xa at an application time point, which is Δt later than an application time point where the scan pulse is applied to the scan electrode Y, i.e., at an application time point ts+Δt. Furthermore, the data pulse are applied to the data electrodes included in the electrode group Xb at an application time point, which is 2Δt later than an application time point where the scan pulse is applied to the scan electrode Y, i.e., at an application time point ts+2Δt. In this manner, the data electrodes included in the electrode group Xc are supplied with the data pulses at an application time point ts+3Δt, and the data electrodes included in the electrode group Xc are supplied with the data pulses at an application time point ts+(n−1)Δt. That is, as shown in FIG. 9b, the data pulses applied to the data electrode groups having data electrodes X₁ to Xn are applied later than the applying time points of the scan pulses applied to the scan electrodes Y.

As shown in FIG. 9c, in the driving waveform according to the driving method of the plasma display apparatus of the present invention, it is assumed that an application time point of the scan pulse applied to the scan electrode Y is ts. According to an arrangement order of the data electrode groups having the data electrodes X₁ to Xn, the data pulse are applied to the data electrodes included in the electrode group Xa at an application time point, which is Δt earlier than an application time point where the scan pulse is applied to the scan electrode Y, i.e., at an application time point ts−Δt. Furthermore, the data pulse are applied to the data electrodes included in the electrode group Xb at an application time point, which is 2Δt earlier than an application time point where the scan pulse is applied to the scan electrode Y, i.e., at an application time point ts−2Δt. In this manner, the data electrodes included in the electrode group Xc are supplied with the data pulses at an application time point ts−3Δt, and the data electrodes included in the electrode group Xc are supplied with the data pulses at an application time point ts−(n−1)Δt. That is, as shown in FIG. 9c, the data pulses applied to the data electrode groups having the data electrodes X₁ to Xn are applied earlier than the applying time points of the scan pulses applied to the scan electrodes Y.

Even in FIGS. 9a to 9c, a difference in an application time point between the data electrode groups can be set to be the same or different as described above.

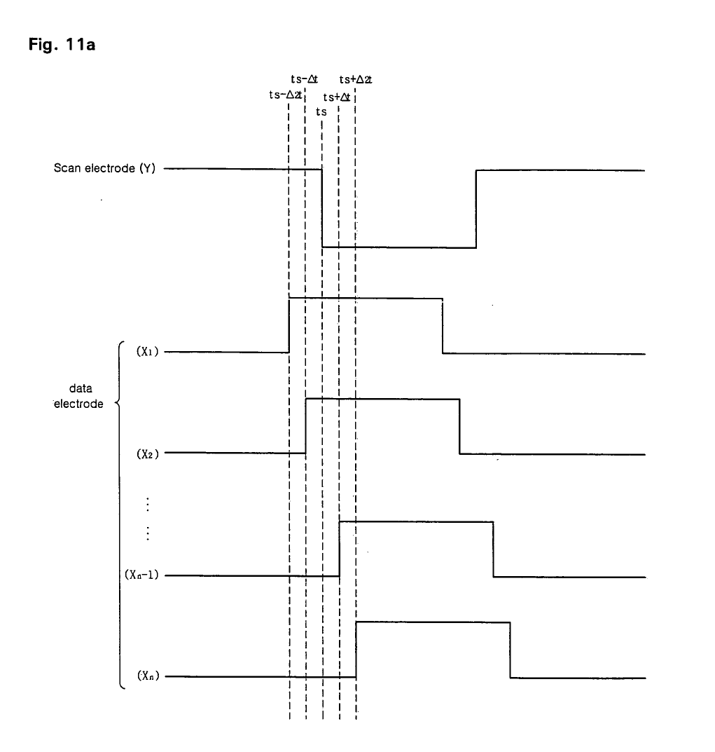

FIG. 10 illustrates an example in which an applying time of a scan pulse and an applying time of a data pulse are set to be different from each other depending on each sub-field within a frame in the method of driving the plasma display apparatus according to the present invention.

Referring to FIG. 10, in the driving waveform according to the method of driving the plasma display apparatus of the present invention, in the same sub-field, a time difference between applying time points of data pulses applied to the data electrodes X is the same, and an application time point of a scan pulse applied to the scan electrode Y and applying time points of data pulses applied to the data electrodes X are different from each other. Furthermore, a time difference in an application time point between data pulses applied to the data electrodes X in an address period of at least one of sub-fields within one frame is different from a time difference in an application time point between data pulses applied to the data electrodes X in address periods of the remaining sub-fields.

In this case, an example of a method of setting applying time points of a data pulse and a scan pulse to be different from each other will be described below. In a first sub-field of one frame, while applying time points of data pulses applied to the data electrodes X₁ to Xn are set to be different from an application time point of a scan pulse applied to the scan electrode Y, a time difference in the applying time point between the data pulses applied to the data electrodes is set to Δt. Furthermore, in the same manner as the first sub-field, in a second sub-field of one frame, while applying time points of data pulses applied to the data electrodes X₁ to Xn are set to be different from an application time point of a scan pulse applied to the scan electrode Y, a time difference in the applying time point between the data pulses applied to the data electrodes is set to 2Δt. In this manner, a time difference in the applying time point between the data pulses applied to the data electrodes can be differently set, such as 3Δt or 4Δt, on a sub-field basis included in one frame.

Alternatively, in the driving waveform of the present invention, in at least one sub-field, while applying time points of the data pulses are set to be different from an application time point of the scan pulse, the applying time points of the data pulses can be set differently on a sub-field basis prior to and subsequent to the applying time point of the scan pulse. For example, in a first sub-field, applying time points of the data pulses can be set prior to front and subsequent to an application time point of the scan pulse. In a second sub-field, applying time points of the data pulses can be all set prior to an application time point of the scan pulse. In a third sub-field, applying time points of the data pulses can be all set subsequent to an application time point of the scan pulse.

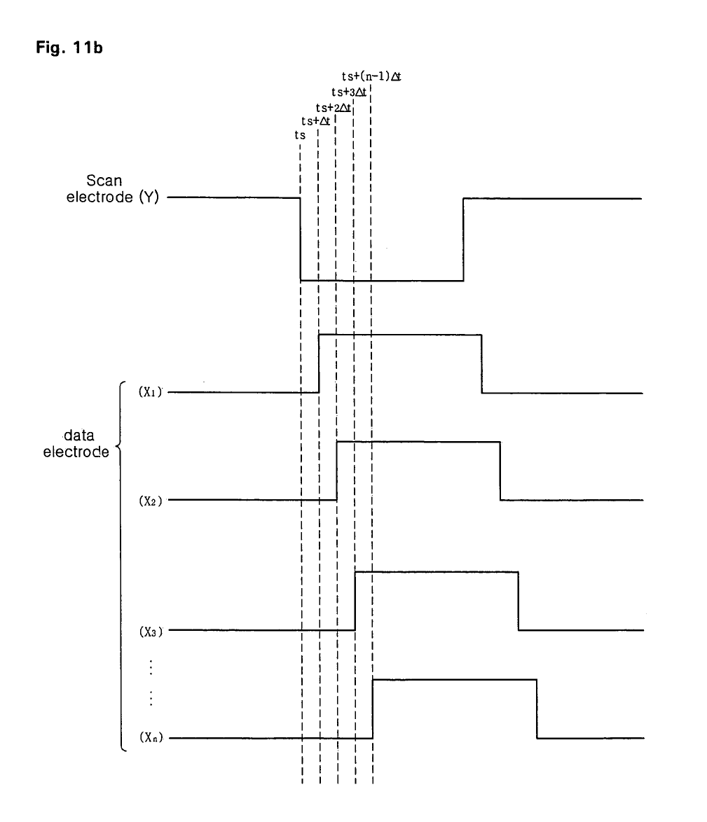

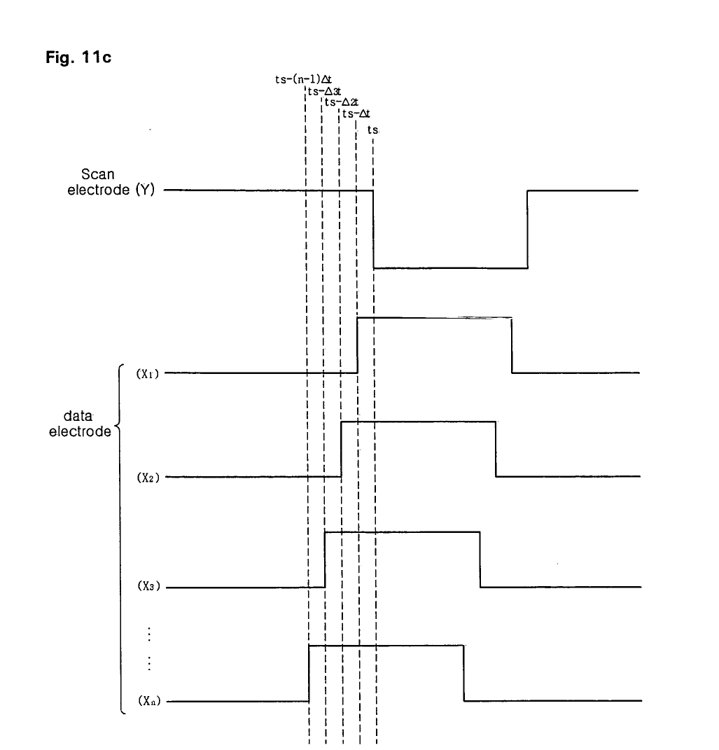

FIGS. 11a to 11c are timing diagrams illustrating, in more detail, the driving waveform of FIG. 10.

Referring to FIG. 11a, in a region D of FIG. 10, an application time point of each of data pulses applied to the data electrodes X₁ to Xn is prior to or subsequent to an application time point of the scan pulse applied to the scan electrode Y.

Referring to FIG. 11b, in a region E of FIG. 10, an application time point of each of data pulses applied to the data electrodes X₁ to Xn is different from an application time point of the scan pulse applied to the scan electrode Y, and the applying time points of the entire data pulses are subsequent to the applying time point of the scan pulse. It has been shown in FIG. 11b that the applying time points of the entire data pulses are set later than the applying time point of the scan pulse. However, only an application time point of one data pulse can be set later than the applying time point of the scan pulse, and the number of the data pulse that is applied later than the applying time point of the scan pulse can also be changed.

Referring to FIG. 11c, in a region F of FIG. 10, applying time points of data pulses applied to the data electrodes X₁ to Xn are set to be different from an application time point of a scan pulse applied to the scan electrode Y, and the applying time points of the entire data pulses are prior to the applying time point of the scan pulse. It has been shown in FIG. 11c that the applying time points of the entire data pulses are set to be prior to the applying time point of the scan pulse. However, an application time point of one data pulse can be set to be prior to the applying time point of the scan pulse, and the number of the data pulse that is applied prior to the applying time point of the scan pulse can also be changed.

As described above, those skilled in the art will appreciate that the present invention can be modified in various manners without depart from the scope and the technical spirit of the present invention. For example, it has been described above that the data pulses are applied to the data electrodes X₁ to Xn at time points different from an application time point where the scan pulse is supplied, or according to arrangement sequence of the entire data electrodes, the data electrodes are divided into four electrode groups having the same number of data electrodes and the data pulses are applied on a electrode-group basis at time points different from an application time point where the scan pulse is applied. Unlike the above, however, an alternative method is possible. In this method, odd-numbered data electrodes of the entire data electrodes X₁ to Xn can be set to one electrode group and odd-numbered data electrodes of the entire data electrodes X₁ to Xn can be set to the other electrode group. In this state, the entire data electrodes within the same electrode group can be supplied with the data pulses at the same application time point, and an application time point of each of the data pulses of each electrode group can be set to be different from an application time point where the scan pulse is applied.

Furthermore, there is another method in which the data electrodes X₁ to Xn are divided into a plurality of electrode groups at least one or more of which have a different number of data electrodes, and the data pulses are applied to each electrode group at an application time point different from an application time point of the scan pulse. For example, assuming that an application time point of the scan pulse applied to the scan electrode Y is ts, the address electrode X₁ can be supplied with a data pulse at an application time point ts+Δt, the data electrodes X₂ to X₁₀ can be supplied with data pulses at ts+3Δt, the data electrodes X₁₁ to Xn can be supplied with data pulses at ts+4Δt, and the like. As described above, the method of driving the plasma display panel of the present invention can be modified in various ways.

An order of scanning a plurality of scan electrodes Y in the address period, which is one of major characteristics of the method of driving the plasma display apparatus according to the present invention, i.e., a method of scanning the scan electrodes Y according to one of a plurality of different scan pulse supply orders will be described below.

One of important factors to decide one of the plurality of scan pulse supply orders is an amount of a displacement current (Id) depending on image data. This will be described with reference to FIG. 12.

FIG. 12 is a view illustrating an amount of a displacement current depending on incoming image data.

Referring to FIG. 12, as shown in (a), when a second scan electrode Y2 is scanned, i.e., when a scan pulse is supplied to the second scan electrode Y2, data electrodes, such as data electrodes X1 to Xm, are supplied with image data having an alternating logic value of 1 (high) and 0 (low). Furthermore, when a third scan electrode Y3 is scanned, the data electrodes X are kept to the logic value 0. The logic value 1 is a state where a voltage of the data pulse, i.e., a state where a data voltage (Vd) is applied to a corresponding data electrode X. The logic value 0 is a state where 0V is applied to a corresponding data electrode X, i.e., a state where the data voltage (Vd) is not applied.

That is, this corresponds a case where image data whose logic value alternates between 1 and 0 are applied to a discharge cell on one scan electrode Y and image data that are kept to the logic value 0 are applied to a discharge cell on a next scan electrode Y. At this time, a displacement current (Id) flowing through each data electrode X can be expressed in the following Equation 1.
Id=½(Cm1+Cm2)Vd [Equation 1]

Id: Displacement current flowing through each data electrode X

Cm1: Equivalent capacitance between data electrodes X

Cm2: Equivalent capacitance between data electrode X and scan electrode Y or between data electrode X and sustain electrode Z

Vd: Voltage of data pulse applied to each data electrode X

As shown in (b), when the second scan electrode Y2 is scanned, image data whose logic value is kept to 1 are supplied to the data electrodes X1 to Xm. Furthermore, when the third scan electrode Y3 is scanned, image data whose logic value is kept to 0 are supplied to the data electrodes X1 to Xm. The logic value 0 is a state where 0V is applied to corresponding data electrodes X, i.e., a state where the data voltage (Vd) is not applied as described above.

That is, this corresponds a case where image data whose logic value is kept to 1 are supplied to a discharge cell on one scan electrode Y and image data whose logic value is kept to 0 are supplied to a discharge cell on a next scan electrode Y. Furthermore, this is true of a case where image data whose logic value is kept to 0 are supplied to a discharge cell on one scan electrode Y and image data whose logic value is kept to 1 are supplied to a discharge cell on a next scan electrode Y.

At this time, the displacement current (Id) flowing through each of the data electrodes X can he expressed in the following Equation 2.
Id=½(Cm2)Vd [Equation 2]

Id: Displacement current flowing through each data electrode X

Cm2: Equivalent capacitance between the data electrodes X and the scan electrodes Y or between the data electrodes X and the sustain electrodes Z

Vd: Voltage of the data pulse, which is applied to each of the data electrodes X

As shown in (c), when the second scan electrode Y2 is scanned, image data whose logic value is alternately changed between 1 and 0 are supplied to the data electrodes X1 to Xm. Furthermore, when the third scan electrode Y3 is scanned, image data whose logic value is alternately changed between 1 and 0 are supplied so that the image data have a phase, which is shifted by 180° from the phase of the image data applied to the discharge cell on the second scan electrode Y2.

That is, the image data whose logic value is alternately changed between 1 and 0 are supplied to a discharge cell on one scan electrode Y. The image data whose logic value is alternately changed between 1 and 0 are supplied to a discharge cell on a next scan electrode Y so that the image data have a phase, which is shifted by 180° from the phase of the image data applied to the discharge cell on one scan electrode Y.

The displacement current (Id) flowing through each of the data electrodes X can be expressed in the following Equation 3.
Id=½(4Cm1+Cm2)Vd [Equation 3]

Id: Displacement current flowing through each of the data electrodes X

Cm2: Equivalent capacitance between the data electrodes X and the scan electrodes Y or between the data electrodes X and the sustain electrodes Z

Vd: Voltage of the data pulse, which is applied to each of the data electrodes X

As shown in (d), when the second scan electrode Y2 is scanned, image data whose logic value is alternately changed between 1 and 0 are supplied to the data electrodes X1 to Xm. Furthermore, when the third scan electrode Y3 is scanned, image data whose logic value is alternately changed between 1 and 0 are supplied so that the image data have the same phase as that of the image data applied to the discharge cell on the second scan electrode Y2.

That is, the image data whose logic value is alternately changed between 1 and 0 are supplied to the discharge cell on one scan electrode Y. The image data whose logic value is alternately changed between 1 and 0 are supplied to a discharge cell on a next scan electrode Y so that the image data have the same phase as that of the image data applied to the discharge cell on one scan electrode Y.

At this time, the displacement current (Id) flowing through each of the data electrodes X can be expressed in the following Equation 4.
Id=0 [Equation 4]

Id: Displacement current flowing through each of the data electrodes X

Cm2: Equivalent capacitance between the data electrodes X and the scan electrodes Y or between the data electrodes X and the sustain electrodes Z

Vd: Voltage of the data pulse, which is applied to each of the data electrodes X

As shown in (e), when the second scan electrode Y2 is scanned, image data whose logic value is kept to 0 are supplied to the data electrodes X1 to Xm. Furthermore, when the third scan electrode Y3 is scanned, image data whose logic value is kept to 0 are also supplied to the data electrodes X1 to Xm.

That is, image data whose logic value is kept to 0 are supplied to a discharge cell on one scan electrode Y, and image data whose logic value is kept to 0 are supplied to a discharge cell on a next scan electrode Y.

Furthermore, this is true of a case where image data whose logic value is kept to 1 are supplied to a discharge cell on one scan electrode Y and image data whose logic value is kept to 1 are supplied to a discharge cell on a next scan electrode Y.

At this time, the displacement current (Id) flowing through each of the data electrodes X can be expressed in the following Equation 5.
Id=0 [Equation 5]

Id: Displacement current flowing through each of the data electrodes X

Cm2: Equivalent capacitance between the data electrodes X and the scan electrodes Y or between the data electrodes X and the sustain electrodes Z

Vd: Voltage of the data pulse, which is applied to each of the data electrodes X

From Equations 1 to 5, it can be seen that a case where image data whose logic value is alternately changed between 1 and 0 are supplied to the discharge cell on one scan electrode Y and image data whose logic value is alternately changed between 1 and 0 are supplied to a discharge on a next scan electrode Y so that the image data have a phase, which is shifted by 180° from a phase of the image data applied to the discharge cell on one scan electrode Y has the highest displacement current flowing through the data electrodes X.

Meanwhile, it can be seen that a case where image data whose logic value is alternately changed between 1 and 0 are supplied to a discharge cell on one scan electrode Y and image data whose logic value is alternately changed between 1 and 0 are supplied to a discharge cell on a next scan electrode Y so that the image data have the same phase as that of the image data applied to the discharge cell on one scan electrode Y, and a case where image data whose logic value is kept to 0 are supplied both to a discharge cell on one scan electrode Y and a discharge cell on a next scan electrodes Y have the lowest displacement current flowing through the data electrodes X.

From the description of FIG. 12, it can be seen that in the case where image data having different logic levels are alternately provided as shown in (c) of FIG. 12, the highest displacement current flows, and a possibility that the data driver IC can experience the greatest electrical damage is the highest in this case.

In other words, from a viewpoint of the data driver IC responsible for one data electrode X, the image data as shown in (c) of FIG. 12 correspond to a case where a switching number of the data driver IC is the highest. Therefore, it can be seen that the greater the switching operation number of the data driver IC, the more the displacement current flowing through the data driver IC and the higher the possibility that the data driver IC may undergo electrical damage.

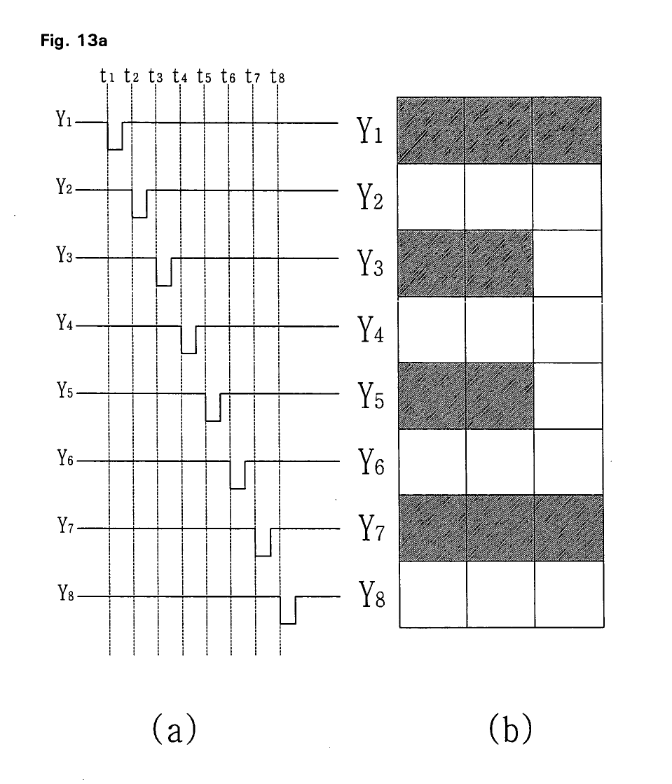

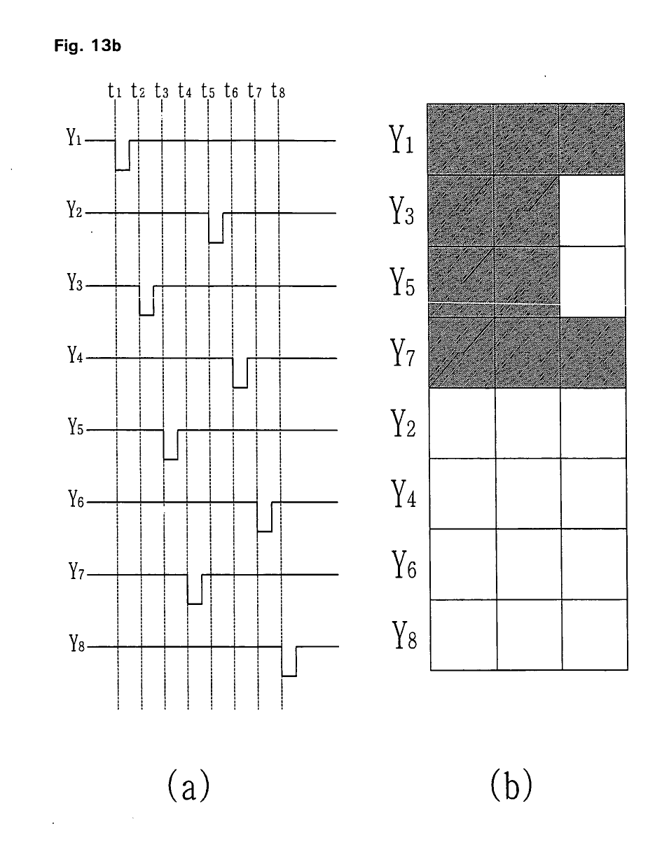

FIGS. 13a and 13b are views illustrating an example of a method of changing a scan order considering image data and a displacement current accordingly.

It can be seen that FIGS. 13a and 13b show the same image data except for its scan order.

Referring first to FIG. 13a, in the case where image data of a pattern as shown in (b) are supplied, if the scan electrodes Y are scanned according to the same order as that of (a), a relatively high displacement current will flow since a logic value of the image data is relatively frequently changed in a direction where the scan electrodes Y are arranged.

If the scan order of the scan electrodes Y is again adjusted as shown in (a) of FIG. 13b, it may result in that the image data of the pattern are arranged as shown in (b) of FIG. 13b. In this case, since the frequency that the logic value of the image data is changed in a direction where the scan electrodes Y are arranged reduces, a displacement current generated will also reduce.

As a result, if the scan order of the scan electrodes Y is controlled according to the image data as shown in FIG. 13b, an amount of a displacement current flowing through the data driver IC can reduce and a possibility that the data driver IC may experience electrical damage will also decrease.

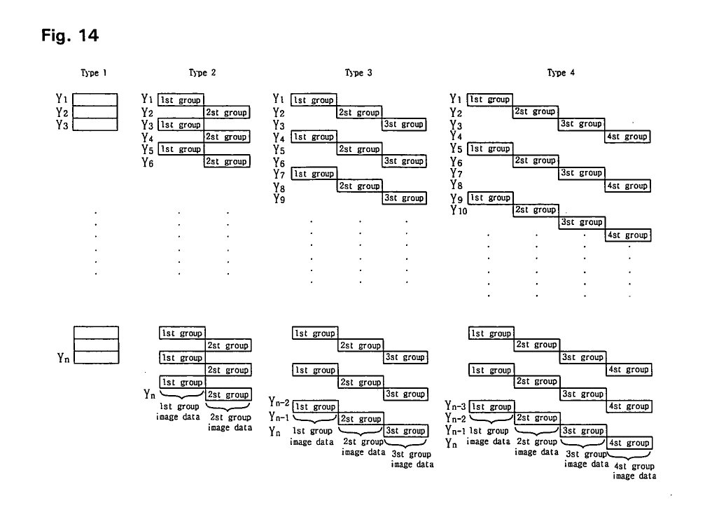

The method of driving the plasma display apparatus according to the present invention has been developed on the basis of the principle as shown in FIGS. 13a and 13b. Another application example in the driving method of the plasma display apparatus according to the present invention will now be described with reference to FIG. 14.

FIG. 14 is a view illustrating another application example in the method of driving the plasma display apparatus according to the present invention.

Referring to FIG. 14, the method of driving the plasma display apparatus according to the present invention can perform scanning according to a selected one of four scan pulse supply orders, i.e., a first type (Type 1), a second type (Type 2), a third type (Type 3) and a fourth type (Type 4).

In the first scan pulse supply order (Type 1), scan pulses are supplied in an order in which the scan electrodes Y are arranged like Y1-Y2-Y3- . . .

In the second scan pulse supply order (Type 2), scan electrodes Y belonging to a first group are sequentially supplied with scan pulses, and scan electrodes Y belonging to a second group are sequentially supplied with scan pulses. That is, the scan electrodes Y1-Y3-Y5-, . . . , Yn-1 are scanned and the scan electrodes Y2-Y4-Y6-, . . . , Yn are scanned.

In the third scan pulse supply order (Type 3), scan electrodes Y belonging to a first group are sequentially supplied with scan pulses and scan electrodes Y belonging to a second group are sequentially supplied with scan pulses. Thereafter, scan electrodes Y belonging to a third group are sequentially supplied with scan pulses. That is, after the scan electrodes Y1-Y4-Y7-, . . . , Yn-2 are scanned and the scan electrodes Y2-Y5-Y8-, . . . , Yn-1 are scanned, the scan electrodes Y3-Y6-Y9-, . . . , Yn are scanned.

In the fourth scan pulse supply order (Type 4), scan electrodes Y belonging to a first group are sequentially supplied with scan pulses and scan electrodes Y belonging to a second group are sequentially supplied with scan pulses. Thereafter, scan electrodes Y belonging to a third group are sequentially supplied with scan pulses, and scan electrodes Y belonging to a fourth group are sequentially supplied with scan pulses. That is, after scan electro Y1-Y5-Y9-, . . . , Yn-3 are scanned, scan electrodes Y2-Y6-Y10-, . . . , Yn-2 are scanned, scan electrodes Y3-Y7-Y11-, Yn-1 are scanned, scan electrodes Y4-Y8-Y12-, . . . , Yn are scanned.

There has been shown in FIG. 14 only the method in which there are four kinds of scan pulse supply orders and the scan electrodes Y are scanned using a selected one of the four kinds of the scan pulse supply orders. Unlike the above, however, the present invention is not limited to the above method. For example, a method is possible in which there are various numbers of scan pulse supply orders, such as two kinds of scan pulse supply orders, three kinds of scan pulse supply orders and five kinds of scan pulse supply orders, and the scan electrodes Y are scanned using a selected one of them.

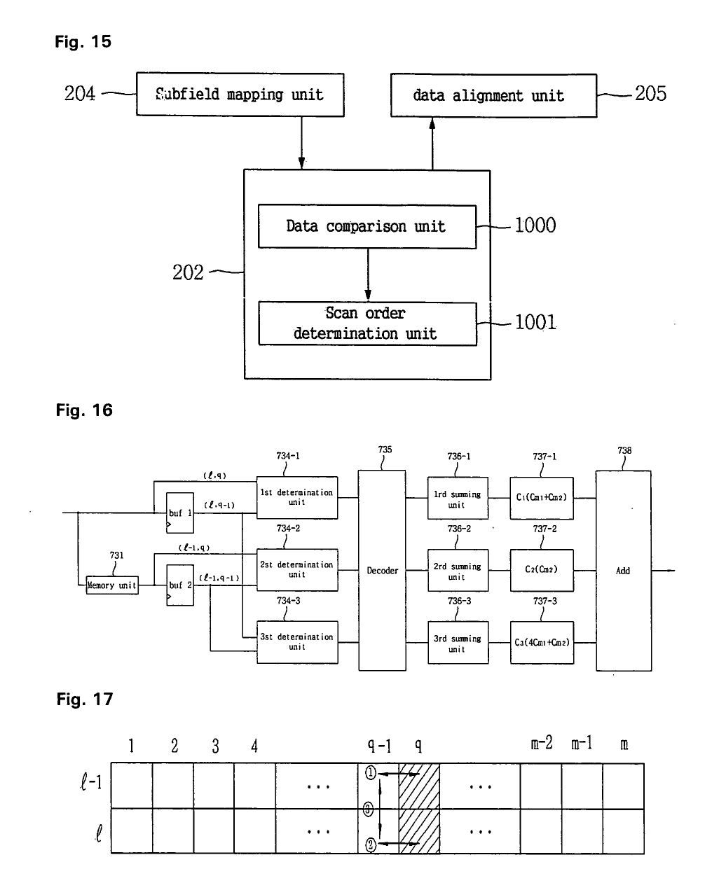

A more detailed construction of the scan driver 202 in FIG. 2, for scanning the scan electrodes Y according to one of a plurality of scan pulse supply orders as described above, will be described below with reference to FIG. 15.

FIG. 15 is a view illustrating, in detail, the construction and operation of a scan driver for realizing the method of driving the plasma display apparatus according to the present invention.

Referring to FIG. 15, the scan driver for implementing the method of driving the plasma display apparatus according to the present invention can comprise a data comparator 1000 and a scan order decision unit 1001.

The data comparator 1000 receives image data, which have been mapped by the sub-field mapping unit 204, and calculates an amount of a displacement current by comparing image data of a cell bundle consisting of one or more discharge cells located on a specific scan electrode Y line and image data of a cell bundle located in vertical and horizontal directions of the cell bundle using each of a plurality of scan pulse supply orders.

The term “cell bundle” refers to that one or more cells are bundled to form one unit. For example, since R, G and B cells are bundled to form one pixel, a pixel corresponds to a cell bundle.

The scan order decision unit 1001 decides a scan order using a scan pulse supply order having the lowest displacement current based on information about the amount of the displacement current, which has been calculated by the data comparator 1000.

Information about the scan order, which has been decided by the scan order decision unit 1001, is provided to the data arrangement unit 205. The data arrangement unit 205 rearranges the image data, which are sub-field mapped by the sub-field mapping unit 204, according the scan order decided by the above scan order decision unit 1001, and supplies the rearranged image data to the data electrodes X.

The construction of the scan driver 202 shown in FIG. 15 will be described in conjunction with the aforementioned FIG. 14. An amount of a displacement current with respect to the four kinds of the scan pulse supply orders in FIG. 14 is calculated by the data comparator 1000 of FIG. 15 and information about the amount of the displacement current with respect to the four kinds of the scan pulse supply orders is provided to the scan order decision unit 1001. The scan order decision unit 1001 then compares the amounts of the displacement currents with respect to the four kinds of the scan pulse supply orders and selects one scan pulse supply order having the lowest displacement current. For example, assuming that an amount of a displacement current with respect to a first scan pulse supply order is 10, an amount of a displacement current with respect to a second scan pulse supply order is 15, an amount of a displacement current with respect to a third scan pulse supply order is 11 and an amount of a displacement current with respect to a fourth scan pulse supply order is 8, the scan order decision unit 1001 selects a fourth scan pulse supply order and decides a scan order of the scan electrodes Y according to the selected fourth scan pulse supply order.

Meanwhile, if amounts of displacement currents with respect to all the scan pulse supply orders of the four kinds of scan pulse supply orders, i.e., the first, third and fourth scan pulse supply orders other than the second scan pulse supply order are sufficiently low in such a way not to cause electrical damage to the data driver IC, the scan order decision unit 1001 can select any one of the first, third and fourth scan pulse supply orders.

In this case, information about current, which is sufficiently low enough not to cause electrical damage to the data driver IC, can be set in advance. That is, the highest value of current, which is sufficiently low enough not to cause electrical damage to the data driver IC, is set as a critical current in advance. A scan pulse supply order where a displacement current lower than the critical current is generated can be selected.

FIG. 16 shows a basic circuit block comprised in a data comparator included in the scan driver of the plasma display apparatus of the present invention.

As shown in FIG. 16, in the plasma display apparatus of the present invention, the basic circuit block comprised in the data comparator 1000 of the scan driver comprises a memory unit 731, a first buffer buf1, a second buffer buf2, first to third decision units 734-1, 734-2 and 734-3, a decoder 735, first to third summation units 736-1, 736-2 and 736-3, first to third current calculators 737-1, 737-2 and 737-3, and a current summation unit 738.

Image data corresponding to a (l-1)^{th} scan electrode, i.e., a (l-1)^{th} scan electrode line are stored in the memory unit 731. Image data corresponding to a l^{th} scan electrode, i.e., a l^{th} scan electrode line are input to the memory unit 731.

The first buffer buf1 temporarily stores image data of a (q-1)^{th} discharge cell of discharge cells corresponding to the l^{th} scan electrode line.

The second buffer buf2 temporarily stores image data of a (q-1)^{th} discharge cell of discharge cells corresponding to the (l-1)^{th} scan electrode line, which are stored in the memory unit 731.

The first decision unit 734-1 comprises an XOR gate element, and it compares the image data of a q^{th} discharge cell of the l^{th} scan electrode line and the image data of the (q-1)^{th} discharge cell of the l^{th} scan electrode line, which are stored in the first buffer buf1. As a result of the comparison, if the two image data are different from each other, the first decision unit 734-1 outputs 1. If the two image data are identical to each other, the first decision unit 734-1 outputs 0.

The second decision unit 734-2 comprises an XOR gate element, and it compares the image data of the q^{th} discharge cell of the (l-1)^{th} scan electrode line and the image data of the (q-1)^{th} discharge cell of the (l-1)^{th} scan electrode line, which are stored in the second buffer buf2. As a result of the comparison, if the two image data are different from each other, the second decision unit 734-2 outputs 1. If the two image data are identical to each other, the second decision unit 734-2 outputs 0.

The third decision unit 734-3 comprises an XOR gate element, and it compares the image data of the (q-1)^{th} discharge cell of the l^{th} scan electrode line, which are stored in the first buffer buf1, and the image data of the (q-1)^{th} discharge cell of the (l-1)^{th} scan electrode line, which are stored in the second buffer buf2. As a result of the comparison, if the two image data are different from each other, the third decision unit 734-3 outputs 1. If the two image data are identical to each other, the third decision unit 734-3 outputs 0.

FIG. 17 is a view illustrating, in more detail, the operation of first to third decision units of a data comparator.) \textcircled{1}, \textcircled{2} and \textcircled{3} correspond to the operations of the first decision unit 734-1, the second decision unit 734-2 and the third decision unit 734-3, respectively.

Referring to FIG. 17, the data comparator 1000 of the present invention compares image data of neighboring cells located in horizontal and vertical directions of one cell using the first decision unit 734-1 to the third decision unit 734-3, and then determines variations in the image data. The decoder 735 outputs a 3-bit signal corresponding to an output signal of each of the first to third decision units 734-1, 734-2 and 734-3.

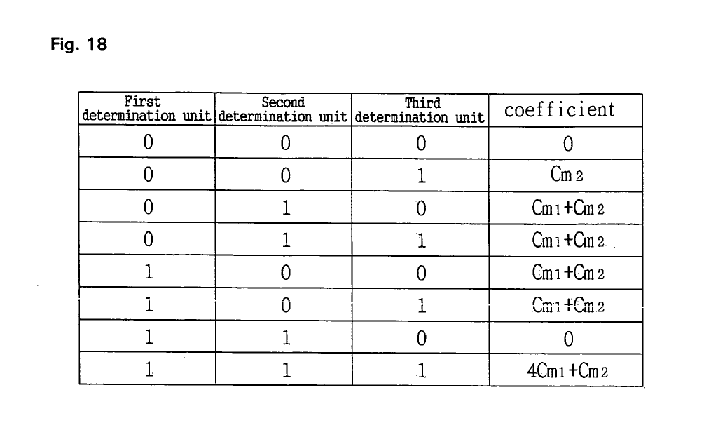

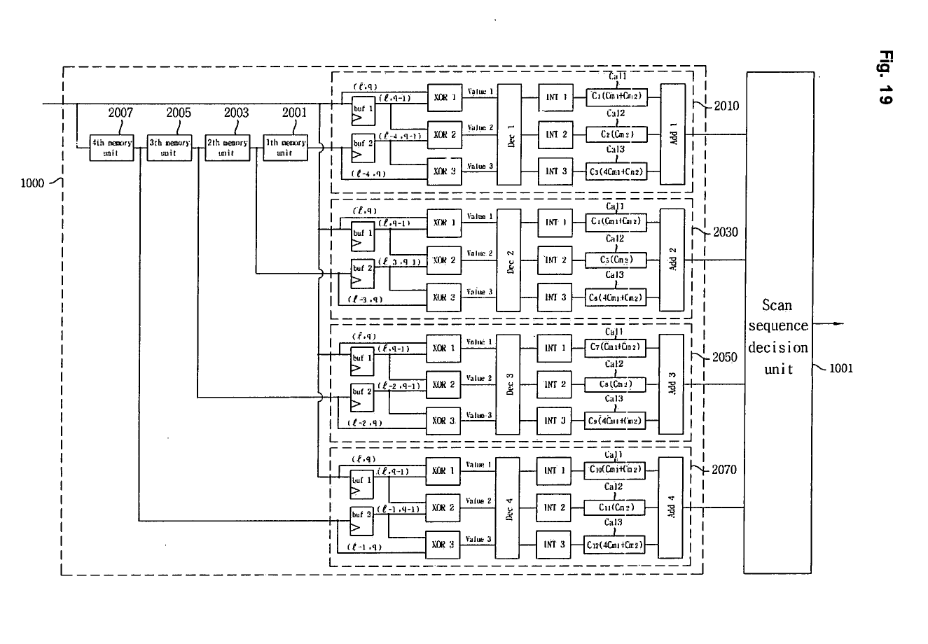

FIG. 18 is a table showing pattern contents of the image data depending on output signals of first to third decision units 734-1, 734-2 and 734-3 comprised in the basic circuit block of the data comparator according to the present invention.

Referring to FIG. 18, if an output signal of each of the first to third decision units 734-1, 734-2 and 734-3 is (0,0,0), this is the same as the pattern state of the image data shown in (a) of FIG. 13. If the output signal is (0,0,0), the displacement current (Id) is 0.

If the output signal of each of the first to third decision units 734-1, 734-2 and 734-3 is (0,0,1), this is the same as the pattern state of the image data, which is shown in (b) of FIG. 13. Therefore, if the output signal is (0,0,1), the displacement current (Id) is proportional to Cm2.

If the output signal of each of the first to third decision units 734-1, 734-2 and 734-3 is any one of (0,1,0) (0,1,1), (1,0,0) and (1,0,1), this is the same as the pattern state of the image data, which is shown in (a) of FIG. 13. Therefore, if the output signal is any one of (0,1,0), (0,1,1), (1,0,0) and (1,0,1), the displacement current (Id) is proportional to (Cm1+Cm2).

If the output signal of each of the first to third decision units 734-1, 734-2 and 734-3 is (1,1,0), this is the same as the pattern state of the image data, which is shown in (d) of FIG. 13. Therefore, if the output signal is (1,1,0), the displacement current (Id) is 0.

If the output signal of each of the first to third decision units 734-1, 734-2 and 734-3 is (1,1,1), this is the same as the pattern state of the image data, which is shown in (c) of FIG. 13. Therefore, if the output signal is (1,1,1), the displacement current (Id) is proportional to (4 Cm1+Cm2).

Furthermore, the first to third summation units 736-1, 736-2 and 736-3 of FIG. 16 sum output numbers of specific 3-bit signals output from the decoder 735, and output the summation result.

That is, the first summation unit 736-1 sums a number in which any one of (0,1,0), (0,1,1), (1,0,0) and (1,0,1) is output by the decoder 735 (C1). The second summation unit 736-2 sums a number in which (0,0,1) is output by the decoder 735 (C2). The third summation unit 736-3 sums a number in which (1,1,1) is output by the decoder 735 (C3).

The first to third current calculators 737-1, 737-2 and 737-3 receive C1, C2 and C3 from the first summation unit 736-1, the second summation unit 736-2 and the third summation unit 736-3, respectively, and calculate amounts of the displacement current.

The current summation unit 738 sums the amounts of the displacement current, which are calculated by the first to third current calculators 737-1, 737-2 and 737-3.

FIG. 19 is a block diagram of the data comparator 1000 and the scan order decision unit 1001 of the scan driver in the plasma display apparatus according to the present invention.

As shown in FIG. 19, in the plasma display apparatus according to the present invention, the data comparator 1000 of the scan driver has a structure in which four basic circuit blocks shown in FIG. 19 are connected. The scan order decision unit 1001 compares the outputs of the four basic circuit blocks to decide a scan order that outputs the lowest displacement current. FIG. 19 corresponds to a case where a scan pulse supply order comprises a total of four scan pulse supply orders as in FIG. 14. That is, FIG. 19 shows the construction of the data comparator 1000 and the scan order decision unit 1001 corresponding to a case where the scan electrodes Y are scanned from the total of four scan pulse supply orders to one scan pulse supply order.

The data comparator 1000 comprises first to fourth memory units 2001, 2003, 2005 and 2007, and first to fourth current decision units 2010, 2030, 2050 and 2070. That is, one memory unit and one current decision unit correspond to the basic circuit block shown in FIG. 16.

The first to fourth memory units 2001, 2003, 2005 and 2007 are interconnected and store image data corresponding to the four scan electrode (Y) lines. That is, the first memory unit 2001 stores image data corresponding to a (l-4)^{th} scan electrode (Y) line. The second memory unit 2003 stores image data corresponding to a (l-3)^{th} scan electrode (Y) line. The third memory unit 2005 stores image data corresponding to a (l-2)^{th} scan electrode (Y) line. The fourth memory unit 907 stores image data corresponding to a (l-1)^{th} scan electrode (Y) line.

The first current decision unit 2010 receives the image data of the l^{th} scan electrode (Y) line and the image data of the (l-4)^{th} scan electrode (Y) line, which are stored in the first memory unit 2001. If the current of the first current decision unit 2010 that has received the image data is lower than the current of the second to fourth current decision units 2030, 2050 and 2070, the scan order is the same as the fourth scan pulse supply order (Type 4) of FIG. 14. That is, scanning has to be performed in order of Y1-Y5-Y9-, . . . , Y2-Y6-Y10-, . . . , Y3-Y7-Y11-, . . . , Y4-Y8-Y12-, . . . .

The operation of the first current decision unit 2010 is the same as that of the basic circuit block. The image data corresponding to the (l-4)^{th} scan electrode (Y) line are stored in the first memory unit 2001, and the image data corresponding to the l^{th} scan electrode (Y) line are input to the first memory unit 2001.

The first buffer buf1 temporarily stores the image data of the (q-1)^{th} discharge cell of the discharge cells corresponding to the l^{th} scan electrode (Y) line.

The second buffer buf2 temporarily stores the image data of the (q-1)^{th} discharge cell of the discharge cells corresponding to the (l-4)^{th} scan electrode (Y) line, which are stored in the first memory unit 2001.

The first decision unit XOR1 comprises an XOR gate element, and it compares image data (l, q) of the q^{th} discharge cell of the l^{th} scan electrode (Y) line and image data (l, q-1) of the (q-1)^{th} discharge cell of the l^{th} scan electrode (Y) line, which are stored in the first buffer buf1. As a result of the comparison, if the two data are different from each other, the first decision unit XOR1 outputs Value=1. If the two data are identical to each other, the first decision unit XOR1 outputs Value=0.

The second decision unit XOR2 comprises an XOR gate element, and it compares image data (l, q-1) of the (q-1)^{th} discharge cell of the l^{th} scan electrode (Y) line and image data (l-4, q-1) of the (q-1)^{th} discharge cell of the (l-4)^{th} scan electrode (Y) line, which are stored in the second buffer buf2. As a result of the comparison, if the two data are different from each other, the second decision unit XOR2 outputs Value=1. If the two data are identical to each other, the first decision unit XOR1 outputs Value=0.

The third decision unit XOR3 comprises an XOR gate element, and it compares image data (l-4, q-1) of the (q-1)^{th} discharge cell of the (l-4)^{th} scan electrode (Y) line, which are stored in the second buffer buf2, and image data (l-4, q) of the q^{th} discharge cell of the (l-4)^{th} scan electrode (Y) line, which are output from the first memory unit 901. As a result of the comparison, if the two data are different from each other, the third decision unit XOR3 outputs Value=1. If the two data are identical to each other, the first decision unit XOR1 outputs Value=0.

The first decoder Dec1 receives the output signals of the first to third decision units XOR1, XOR2 and XOR3 in parallel and then outputs 3-bit signals.

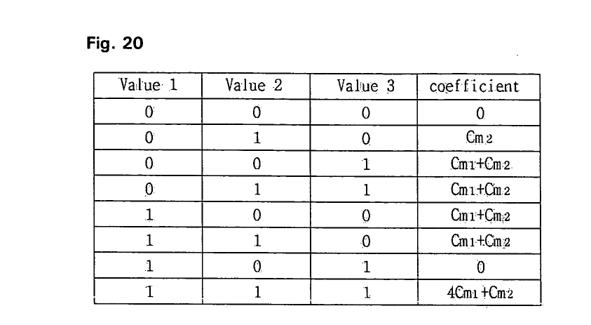

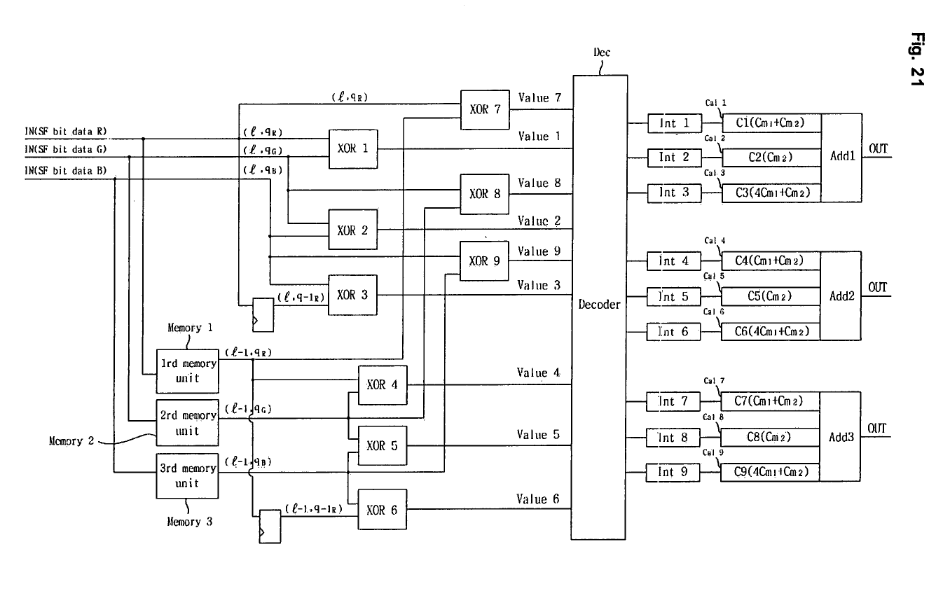

FIG. 20 is a table showing the pattern contents of the image data depending on output signals of first to third decision units XOR1, XOR2 and XOR3 comprised in the data comparator according to the present invention.

Referring to FIG. 20, an amount of capacitance that decides an amount of a displacement current is varied depending on output signals (Value1, Value2, Value3) of the first to third decision units XOR1, XOR2 and XOR3.

First to third summation units Int1, Int2 and Int3 sum output numbers of specific 3-bit signals, which are output from the first decoder Dec1, and output the sum results.

That is, the first summation unit Int1 sums (C1) a number in which any one of (0,0,1), (0,1,1), (1,0,0) and (1,1,0) is output by the first decoder Dec1. The second summation unit Int2 sums (C2) a number in which (0,1,0) is output by the first decoder Dec1. The third summation unit Int3 sums (C3) a number in which (1,1,1) is output by the first decoder Dec1.

First to third current calculators Cal1, Cal2, Cal3 receive C1, C2 and C3 from the first summation units Int1, the second summation unit Int2 and the third summation unit Int3, respectively, and calculate amounts of the displacement current.

That is, the first current calculator Cal1 calculates the amount of current by multiplying the output (C1) of the first summation unit Int1 and (Cm1+Cm2). The second current calculator Cal2 calculates the amount of current by multiplying the output (C2) of the second summation unit Int2 and Cm2. The third current calculator Cal3 calculates the amount of current by multiplying the output (C3) of the third summation unit Int3 and (4Cm1+Cm2).

A first current summation unit Add1 sums the amounts of the displacement current, which are calculated by the first to third current calculators Cal1, Cal2 and Cal3.

In the same manner as the operation of the first current decision unit, the second to fourth current decision units 2030, 2050 and 2070 also calculate the summed amounts of the displacement current.

The first decision unit XOR1 of the second current decision unit 2030 comprises an XOR gate element, and it compares the image data (l, q) of the q^{th} discharge cell of the l^{th} scan electrode (Y) line and the image data (l, q-1) of the (q-1)^{th} discharge cell of the l^{th} scan electrode (Y) line, which are stored in the first buffer buf1. As a result of the comparison, if the two image data are different from each other, the first decision unit XOR1 outputs 1. If the two image data are identical to each other, the first decision unit XOR1 outputs 0.

The second decision unit XOR2 of the second current decision unit 2030 comprises an XOR gate element, and it compares the image data (l, q-1) of the (q-1)^{th} discharge cell of the l^{th} scan electrode (Y) line and the image data (l-3, q-1) of the (q-1)^{th} discharge cell of the (l-3)^{th} scan electrode (Y) line, which are stored in the second buffer buf2. As a result of the comparison, if the two image data are different from each other, the second decision unit XOR2 outputs 1. If the two image data are identical to each other, the second decision unit XOR2 outputs 0.

The third decision unit XOR3 of the second current decision unit 2030 comprises an XOR gate element, and it compares the image data (l-3, q-1) of the (q-1)^{th} discharge cell of the (l-3)^{th} scan electrode (Y) line, which are stored in the second buffer buf2, and the image data (l-3,

q) of the q^{th} discharge cell of the (l-3)^{th} scan electrode (Y) line, which are output the second memory unit 2003. As a result of the comparison, if the two image data are different from each other, the third decision unit XOR3 outputs 1. If the two image data are identical to each other, the third decision unit XOR3 outputs 0.

Furthermore, the first decision unit XOR1 of the third current decision unit 2050 comprises an XOR gate element, and it compares the image data (l, q) of the q^{th} discharge cell of the l^{th} scan electrode (Y) line and the image data (l, q-1) of the (q-1)^{th} discharge cell of the l^{th} scan electrode (Y) line, which are stored in the first buffer buf1. As a result of the comparison, if the two image data are different from each other, the first decision unit XOR1 outputs 1. If the two image data are identical to each other, the first decision unit XOR1 outputs 0.

The second decision unit XOR2 of the third current decision unit 2050 comprises an XOR gate element, and it compares the image data (l, q-1) of the (q-1)^{th} discharge cell of the l^{th} scan electrode (Y) line and the image data (l-2, q-1) of the (q-1)^{th} discharge cell of the (l-2)^{th} scan electrode (Y) line, which are stored in the second buffer buf2. As a result of the comparison, if the two image data are different from each other, the second decision unit XOR2 outputs 1. If the two image data are identical to each other, the second decision unit XOR2 outputs 0.

The third decision unit XOR3 of the third current decision unit 2050 comprises an XOR gate element, and it compares the image data (l-2, q-1) of the (q-1)^{th} discharge cell of the (l-2)^{th} scan electrode (Y) line, which are stored in the second buffer buf2, and the image data (l-2, q) of the q^{th} discharge cell of the (l-2)^{th} scan electrode (Y) line, which are output from the third memory unit 2005. As a result of the comparison, if the two image data are different from each other, the third decision unit XOR3 outputs 1. If the two image data are identical to each other, the third decision unit XOR3 outputs 0.

The first decision unit XOR1 of the fourth current decision unit 2070 comprises an XOR gate element, and it compares the image data (l, q) of the q^{th} discharge cell of the l^{th} scan electrode (Y) line and the image data (l, q-1) of the (q-1)^{th} discharge cell of the l^{th} scan electrode (Y) line, which are stored in the first buffer buf1. As a result of the comparison, if the two image data are different from each other, the first decision unit XOR1 outputs 1. If the two image data are identical to each other, the first decision unit XOR1 outputs 0.

The second decision unit XOR2 of the fourth current decision unit 2070 comprises an XOR gate element, and it compares the (q-1)^{th} image data (l, q-1) of the l^{th} scan electrode (Y) line and the image data (l-l, q-1) of the (q-1)^{th} discharge cell of the (l-1)^{th} scan electrode (Y) line, which are stored in the second buffer buf2. As a result of the comparison, if the two image data are different from each other, the second decision unit XOR2 outputs 1. If the two image data are identical to each other, the second decision unit XOR2 outputs 0.

The third decision unit XOR3 of the fourth current decision unit 2070 comprises an XOR gate element, and it compares the image data (l-1, q-1) of the (q-1)^{th} discharge cell of the (l-1)^{th} scan electrode (Y) line, which are stored in the second buffer buf2, and the image data (l-1, q) of the q^{th} discharge cell of the (l-1)^{th} scan electrode (Y) line, which are output from the fourth memory unit 2007. As a result of the comparison, if the two image data are different from each other, the third decision unit XOR3 outputs 1. If the two image data are identical to each other, the third decision unit XOR3 outputs 0.

The scan order decision unit 1001 receives the amounts of the displacement current, which have been calculated by the first to fourth current decision units 2010, 2030, 2050 and 2070, and then decides a scan order according to a current decision unit that has output the lowest displacement current, or decides a scan order of the scan electrodes Y according to any one of the scan pulse supply orders, in which a displacement current lower than a previously set critical current is generated.

For example, if the scan order decision unit 1001 determines that the amount of the displacement current received from the second current decision unit 2030 is the lowest, the scan order decision unit 1001 sets a scan order so that scanning is performed in order of Y1-Y4-Y7-, Y2-Y5-Y8-, . . . , Y3-Y6-Y9-, . . . , in the same manner as the third scan pulse supply order (Type 3) of FIG. 16.

Furthermore, if the scan order decision unit 1001 determines that the amount of the displacement current received from the third current decision unit 2050 is the lowest, the scan order decision unit 1001 sets the scan order so that scanning is performed in order of Y1-Y3-Y5-, . . . , Y2-Y4-Y6-, . . . , in the same manner as the second scan pulse supply order (Type 2) of FIG. 16.

If the scan order decision unit 1001 determines that the amount of the displacement current received from the fourth current decision unit 2070 is the lowest, the scan order decision unit 1001 sets the scan order so that scanning is performed in order of Y1-Y2-Y3-Y4-Y5-Y6-, . . . , in the same manner as the first scan pulse supply order (Type 1) of FIG. 16.

Meanwhile, in the plasma display apparatus of the present invention, which has been described with reference to FIG. 16, the basic circuit block comprised in the data comparator 1000 of the scan driver can be constructed differently from that of FIG. 16. This will be described below with reference to FIG. 21.

FIG. 21 is a block diagram illustrating another construction of a basic circuit block comprised in the data comparator 1000, which is comprised in the scan driver of the plasma display apparatus according to the present invention.

Referring to FIG. 21, the basic circuit block of FIG. 21 calculates an amount of the displacement current through variation in image data corresponding to R, G and B cells of a q^{th} pixel and a (q-1)^{th} pixel on the l^{th} scan electrode line, variation in image data corresponding to R, G and B cells of the q^{th} pixel and the (q-1)^{th} pixel on the (l-1)^{th} scan line, and variation in image data corresponding to R, G and B cells of the q^{th} pixel on the l^{th} scan electrode line and the (q-1)^{th} pixel on the (l-1)^{th} scan electrode line.

First to third memory units Memory1, Memory2 and Memory3 temporarily store the image data corresponding to the R cell of the (l-1)^{th} scan electrode line, the image data corresponding to the G cell of the (l-1)^{th} scan electrode line, and the image data corresponding to the B cell of the (l-1)^{th} scan electrode line, respectively.

The first to third decision units XOR1, XOR2 and XOR3 decide variation between the image data corresponding to the R, G and B cells of the q^{th} pixel on the l^{th} scan electrode line.

That is, the first decision unit XOR1 compares image data (l, qR) corresponding to the R cell of the q^{th} pixel on the l^{th} scan electrode line and image data (l, qG) corresponding to the G cell of the q^{th} pixel on the l^{th} scan electrode line. As a result of the comparison, if the two data are different from each other, the first decision unit XOR1 outputs the logic value 1. If the two data are identical to each other, the first decision unit XOR1 outputs the logic value 0.

The second decision unit XOR2 compares image data (l, qG) corresponding to the G cell of the q^{th} pixel on the l^{th} scan electrode line and image data (l, qB) corresponding to the B cell of the q^{th} pixel on the l^{th} scan electrode line. As a result of the comparison, if the two data are different from each other, the second decision unit XOR2 outputs the logic value 1. If the two data are identical to each other, the first decision unit XOR1 outputs the logic value 0.

The third decision unit XOR3 compares image data (l, qB) corresponding to the B cell of the q^{th} pixel on the l^{th} scan electrode line and image data (l, q-1R) corresponding to the R cell of the (q-1)^{th} pixel on the l^{th} scan electrode line. As a result of the comparison, if the two data are different from each other, the third decision unit XOR3 outputs the logic value 1. If the two data are identical to each other, the first decision unit XOR1 outputs the logic value 0.

The fourth to sixth decision units XOR4, XOR5 and XOR6 decide variation between the image data corresponding to the R, G and B cells of the q^{th} pixel on the (l-1)^{th} scan electrode line.

That is, the fourth decision unit XOR4 compares image data (l-1, qR) corresponding to the R cell of the q^{th} pixel on the (l-1)^{th} scan electrode line and image data (l-1, qG) corresponding to the G cell of the q^{th} pixel on the (l-1)^{th} scan electrode line. As a result of the comparison, if the two data are different from each other, the fourth decision unit XOR4 outputs the logic value 1. If the two data are identical to each other, the first decision unit XOR1 outputs the logic value 0.

The fifth decision unit XOR5 compares image data (l-1, qG) corresponding to the G cell of the q^{th} pixel on the (l-1, 1)^{th} scan electrode line and image data (l-l, qB) corresponding to the B cell of the q^{th} pixel on the (l-1)^{th} scan electrode line. As a result of the comparison, if the two data are different from each other, the fifth decision unit XOR5 outputs the logic value 1. If the two data are identical to each other, the first decision unit XOR1 outputs the logic value 0.

The sixth decision unit XOR6 compares image data (l-1, qB) corresponding to the B cell of the q^{th} pixel on the (l-1)^{th} scan electrode line and image data (l-1, q-1R) corresponding to the R cell of the (q-1)th pixel on the (l-1)^{th} scan electrode line. As a result of the comparison, if the two data are different from each other, the sixth decision unit XOR6 outputs the logic value 1. If the two data are identical to each other, the first decision unit XOR1 outputs the logic value 0.

The seventh to ninth decision units XOR7, XOR8 and XOR9 decide variation between the image data by comparing the image data corresponding to the R, G and B cells of the q^{th} pixel on the l^{th} scan electrode line and the image data corresponding to the R, G and B cells of the q th pixel on the (l-1)^{th} scan electrode line, respectively.

That is, the seventh decision unit XOR7 compares the image data (l, qR) corresponding to the R cell of the q^{th} pixel on the l^{th} scan electrode line and the image data (l-1, qR) corresponding to the R cell of the q^{th} pixel on the (l-1)^{th} scan electrode line. As a result of the comparison, if the two data are different from each other, the seventh decision unit XOR7 outputs the logic value 1. If the two data are identical to each other, the first decision unit XOR1 outputs the logic value 0.

The eighth decision unit XOR8 compares the image data (l, qG) corresponding to the G cell of the q^{th} pixel on the l^{th} scan electrode line and the image data (l-1, qG) corresponding to the G cell of the q^{th} pixel on the (l-1)^{th} scan electrode line. As a result of the comparison, if the two data are different from each other, the eighth decision unit XOR8 outputs the logic value 1. If the two data are identical to each other, the first decision unit XOR1 outputs the logic value 0.

The ninth decision unit XOR9 compares the image data (l, qB) corresponding to the B cell of the q^{th} pixel on the l^{th} scan electrode line and the image data (l-1, qB) corresponding to the B cell of the q^{th} pixel on the (l-1)^{th} scan electrode line. As a result of the comparison, if the two data are different from each other, the ninth decision unit XOR9 outputs the logic value 1. If the two data are identical to each other, the first decision unit XOR1 outputs the logic value 0.

The decoder Dec outputs 3-bit signals corresponding to the output signals (Value1, Value2 and Value3) of the first to third decision units XOR1, XOR2 and XOR3, the output signals (Value4, Value5 and Value6) of the fourth to sixth decision units XOR4, XOR5 and XOR6, and the output signals (Value7, Value8 and Value9) of the seventh to ninth decision units XOR7, XOR8 and XOR9.

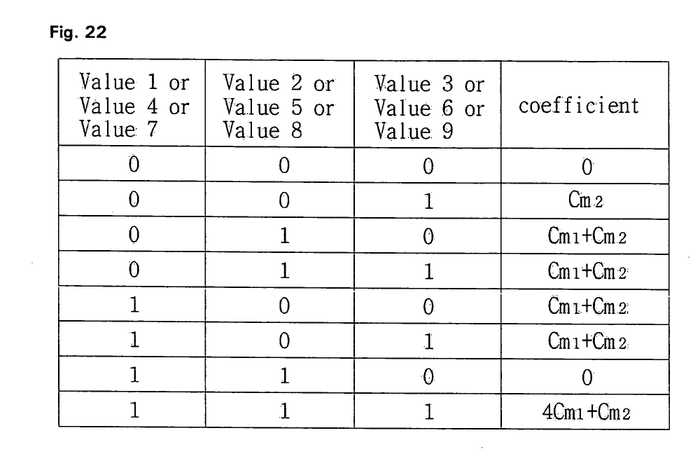

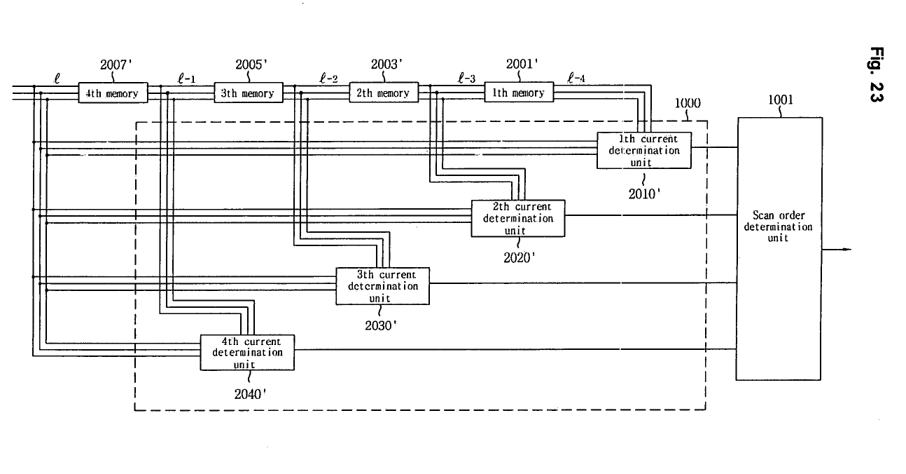

FIG. 22 is a table showing he pattern contents of the image data depending on output signals of first to ninth decision units XOR1 to XOR9 comprised in the circuit block of FIG. 21 according to the present invention.

Referring to FIG. 22, the first to third summation units Int1, Int2 and Int3 sum (C1, C2, C3) the output numbers of the 3-bit signals, which are output from the decoder Dec and correspond to the output signals (Value1, Value2 and Value3) of the first to third decision units XOR1, XOR2 and XOR3, respectively, and then outputs the summation results.

The fourth to sixth summation units Int4, Int5 and Int6 sum (C4, C5 and C6) the output numbers of the 3-bit signals, which are output from the decoder Dec and correspond to the output signals (Value4, Value5 and Value6) of the fourth to sixth decision units XOR4, XOR5 and XOR6, respectively, and then outputs the summation results.

The seventh to ninth summation units Int7, Int8 and Int9 sum (C7, C8 and C9) the output numbers of the 3-bit signals, which are output from the decoder Dec and correspond to the output signals (Value7, Value8 and Value9) of the ninth decision units XOR7, XOR8 and XOR9, respectively, and then outputs the summation results.

The first to third current calculators Cal1, Cal2 and Cal3 receive C1, C2 and C3 from the first, second and third summation units Int1, Int2 and Int3, respectively, and calculate amounts of the displacement current.

The fourth to sixth current calculators Cal4, Cal5 and Cal6 receive C4, C5 and C6 from the fourth, firth and sixth summation units Int4, Int5 and Int6, respectively, and calculate amounts of the displacement current.

The seventh to ninth current calculators Cal7, Cal8 and Cal9 receive C7, C8 and C9 from the seventh to ninth summation units Int7, Int8 and Int9, respectively, and calculate amounts of the displacement current.

The first current summation unit Add1 sums the amounts of the displacement current, which are calculated by the first to third current calculators Cal1, Cal2 and Cal3.

The second current summation unit Add2 sums the amounts of the displacement current, which are calculated by the fourth to sixth current calculators Cal4, Cal5 and Cal6.

The third current summation unit Add3 sums the amounts of the displacement current, which are calculated by the seventh to ninth current calculators Cal7, Cal8 and Cal9.

As described above, an amount of the displacement current with respect to variation in image data corresponding to each cell can be calculated.

FIG. 23 is a block diagram of the data comparator 1000 and the scan order decision unit 1001 of the scan driver in the plasma display apparatus according to the present invention taking FIGS. 21 and 22 into consideration.

Referring to FIG. 23, the data comparator 1000 taking FIGS. 21 and 22 into consideration has a structure in which four basic circuit blocks shown in FIG. 23, i.e., first to fourth current decision units 2010′, 2020′, 2030′ and 2040′ are connected. The scan order decision unit 1001 compares the outputs of the four basic circuit blocks and decides a scan order that generates the lowest displacement current.

The first current decision unit 2010′ compares the image data (l, qR) and the image data (l, qG), the image data (l, qG) and the image data (l, qB), the image data (l, qB) and the image data (l, q-4R), the image data (l-4, qR) and the image data (l-4, qG), the image data (l-4, qG) and the image data (l-4, qB), the image data (l-4, qB) and (l-4, q-1R), the image data (l, qR) and the image data (l-4, qR), the image data (l, qG) and (l-4, qG), and the image data (l, qB) and the image data (l-4, qB), respectively.

At this time, “l” and “l-4” refer to the l^{th} scan electrode line and the (l-4)^{th} scan electrode line, respectively. “qR”, “qG” and “qB” refer to the R, G and B cells of the q^{th} pixel, respectively. “q-1R”, “q-1G” and “q-1B” refer to the R, G and B cells of the (q-1)^{th} pixel, respectively.

Therefore, the first current decision unit 2010′ compares the image data and calculates an amount of the displacement current, which corresponds to the scan order of Type 4 as described above.

The second current decision unit 2020′ compares the image data (l, qR) and the image data (l, qG), the image data (l, qG) and the image data (l, qB), the image data (l, qB) and the image data (l, q-1R), the image data (l-3, qR) and the image data (l-3, qG), the image data (l-3, qG) and the image data (l-3, qB), the image data (l-3, qB) and (l-3, q-1R), the image data (l, qR) and the image data (l-3, qR), the image data (l, qG) and (l-3, qG), and the image data (l, qB) and the image data (l-3, qB), respectively. l and (l-3) refer to the l^{th} scan electrode line and the (l-3)^{th} scan electrode line, respectively.

Therefore, the second current decision unit 2020′ compares the image data and calculates an amount of the displacement current, which corresponds to the scan order of Type 3, as described above.

The third current decision unit 2030′ compares the image data (l, qR) and the image data (l, qG), the image data (l, qG) and the image data (l, qB), the image data (l, qB) and the image data (l, q-1R), the image data (l-2, qR) and the image data (l-2, qG), the image data (l-2, qG) and the image data (l-2, qB), the image data (l-2, qB) and (l-2, q-1R), the image data (E, qR) and the image data (l-2, qR), the image data (l, qG) and the image data (l-2, qG), and the image data (l, qB) and the image data (l-2, qB), respectively. l and (l-2) refer to the l^{th} scan electrode line and the (l-2)^{th} scan electrode line, respectively.

Therefore, the third current decision unit 2030′ compares the image data and calculates an amount of the displacement current, which corresponds to the scan order of Type 2 as described above.

The fourth current decision unit 2040′ compares the image data (l, qR) and the image data (l, qG), the image data (l, qG) and the image data (l, qB), the image data (l, qB) and the image data (l, q-1R), the image data (l-1, qR) and the image data (l-1, qG), the image data (l-1, qG) and the image data (l-1, qB), the image data (l-1, qB) and the image data (l-1, q-1R), the image data (l, qR) and the image data (l-1, qR), the image data (l, qG) and (l-1, qG), and the image data (l, qB) and the image data (l-1, qB), respectively. l and (l-1) refer to the l^{th} scan electrode line and the (l-1)^{th} scan electrode line, respectively.

The fourth current decision unit 2040′ compares the image data and calculates an amount of the displacement current, which corresponds to the scan order of Type 1, as described above.

The scan order decision unit 1001 receives the amounts of the displacement current, which are calculated by the first to fourth current decision units 2010′, 2030′, 2050′ and 2070′, and decides a scan order according to a current decision unit that has output the lowest displacement current.

For example, if the scan order decision unit 1001 determines that the amount of the displacement current, which is received from the second current decision unit 2030′, is the lowest, the scan order decision unit 1001 sets the scan order so that scanning is performed in order of Y1-Y4-Y7-, . . . , Y2-Y5-Y8-, . . . , Y3-Y6-Y9- . . . , in the same manner as the third scan pulse supply order (Type 3) of FIG. 21.

Furthermore, if the scan order decision unit 1001 determines that the amount of the displacement current, which is received from the third current decision unit 2050′, is the lowest, the scan order decision unit 1001 sets the scan order so that scanning is performed in order of Y1-Y3-Y5-, . . . , Y2-Y4-Y6-, . . . , in the same manner as the second scan pulse supply order (Type 2) of FIG. 14.

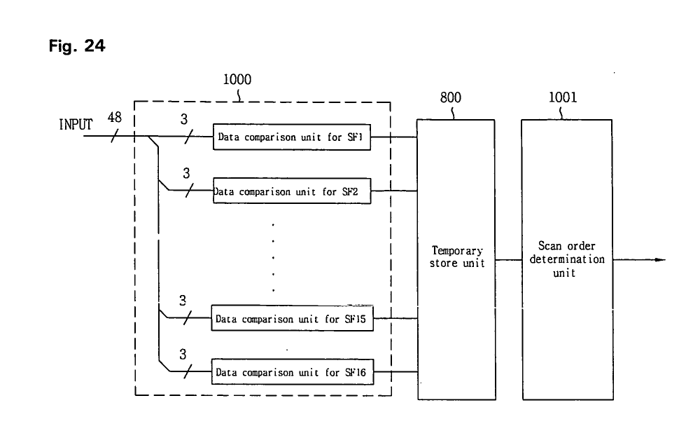

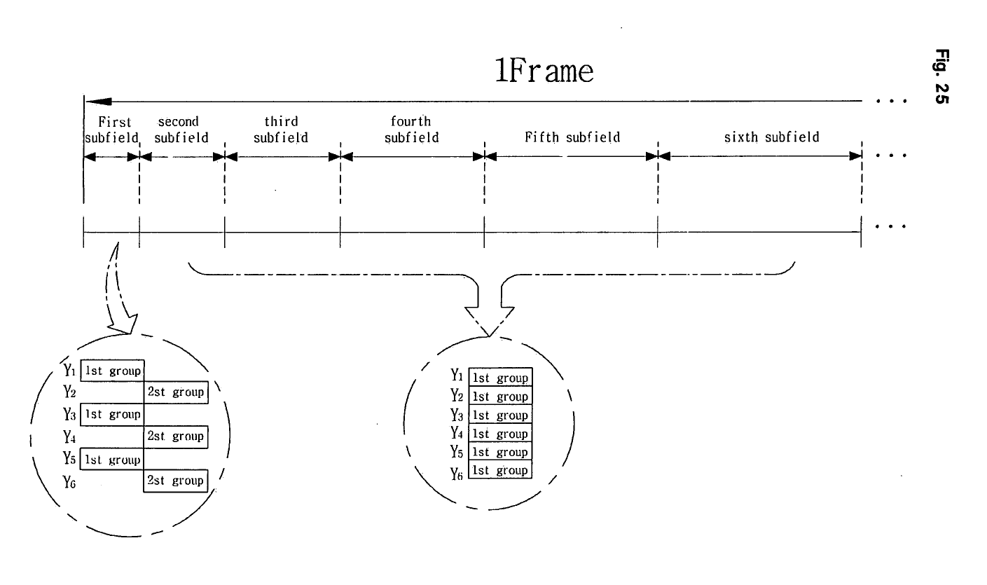

FIG. 24 is a block diagram of an embodiment in which the data comparator and the scan order decision unit according to the present invention are applied on a sub-field basis.

Referring to FIG. 24, each of a data comparator for a first sub-field (SF1) to a data comparator for a sixteenth sub-field (SF16) calculates an amount of the displacement current according to an image pattern in a corresponding sub-field with respect to a plurality of scan pulse supply orders, and stores the calculated amount in a buffer 800.

Each of the data comparator for the first sub-field (SF1) to the data comparator for the sixteenth sub-field (SF16) is the same as the block construction of the data comparator shown in FIG. 19. Each of the data comparator for the first sub-field (SF1) to the data comparator for the sixteenth sub-field (SF16) calculates an amount of the displacement current according to a pattern of image data in each sub-field with respect to a plurality of scan pulse supply orders, and stores the calculated amount in the buffer 800.

The scan order decision unit 1001 compares the amounts of the displacement current according to the patterns of the image data for the respective sub-fields, which are received from the buffer 800, knows the pattern of the image data having the lowest displacement current, and decides a scan order every sub-field.

In the plasma display apparatus and driving method thereof of the present invention as described above, the displacement current between the scan electrode lines corresponding to a plurality of scan pulse supply orders are calculated, and lines corresponding to the scan pulse supply orders having the lowest displacement current are sequentially scanned.

That is, it has been shown in FIG. 14 that a displacement current between lines in which scan pulse supply orders are spaced apart one another at regular intervals by a predetermined number is calculated, and a scan pulse supply order having the lowest displacement current is selected. However, a displacement current between lines in which scan pulse supply orders are spaced apart one another irregularly or according to a predetermined rule can be calculated, and a scan pulse supply order having the lowest displacement current can be selected. Furthermore, it has been described above that the displacement current is calculated using weights (Cm2, Cm1+Cm2, or 4 Cm1+Cm2), which comprise at least one of capacitances (Cm1 and Cm2). However, the amounts of the displacement currents of the sub-fields can be found by summing the values of “u0”v or “u1”v in such a manner that in the case where weights are not used and the displacement current does not flow, the amount of the displacement current is set to “u0”v and in the case where the displacement current flows, the amount of the displacement current is set to “u1”v. For example, in FIG. 16, the first to third summation units 736-1 to 736-3 can be constructed using one summation unit, and the current calculators 737-1 to 737-3 and the current summation unit 738 may be omitted. In this case, one summation unit can count the output numbers of C1, C2 and C3 and calculates the count values themselves as displacement currents.

FIG. 25 is a view illustrating an example of a method of selecting a sub-field that scans scan electrodes Y according to any one of a plurality of scan pulse supply orders within one frame.

Referring to FIG. 25, the scan electrodes Y are scanned using the first scan pulse supply order (Type 1) of FIG. 14 only in a first sub-field having the lowest gray level weight, of sub-fields comprised in one frame, and the scan electrodes Y are scanned according to a general method, i.e., a sequential scanning method in the remaining sub-fields. In more detail, the displacement current for a plurality of scan pulse supply orders is calculated in selected one or more of sub-fields comprised in one frame, and the scan electrodes Y are then scanned using a scan pulse supply order in which the displacement current is the lowest in each sub-field.

It is, however, more preferred that the displacement current with respect to the plurality of scan pulse supply orders are calculated in the respective sub-fields comprised in one frame, and the scan electrodes Y are scanned according to a scan pulse supply order in which the displacement current is the lowest in each sub-field as shown in FIG. 24.

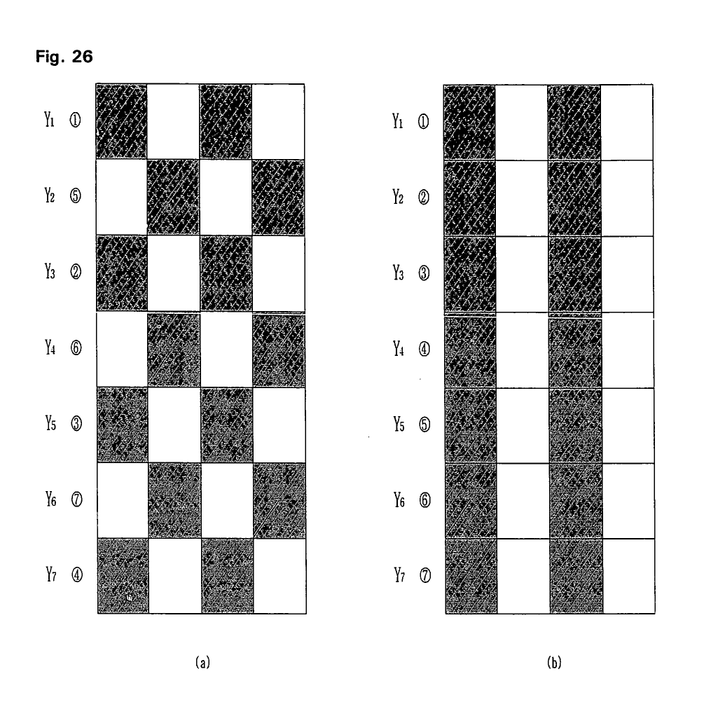

Considering the above description, in the case where patterns of image data comprise a first pattern and a second pattern, it can be seen that a scan order in the first pattern of the image data and a scan order in the second pattern of the image data can be different from each other. This will be described in more detail with reference to FIG. 26.

FIG. 26 is a view illustrating that scan orders can be different from each other in patterns of two different image data.

Referring to FIG. 26, (a) shows a pattern of image data, in which the logic level “1” and the logic level “0” are alternately disposed in up and down directions and right and left directions. (b) shows a pattern of image data, in which the logic levels “1” and “0” are alternately disposed in right and left directions, but the logic levels “1” and “0” are not changed in up and down directions.

In the case of the image data pattern of (a), the scan order of the scan electrodes Y is Y1-Y3-Y5-Y7-Y2-Y4-Y6. In the case of the image data pattern of (b), the scan order of the scan electrodes Y is Y1-Y2-Y3-Y4-Y5-Y6-Y7. That is, the scan order of the scan electrodes Y is different in the case where the image data have the pattern as shown in (a) and the image data have the pattern as shown in (b).

The reason why the scan order of the scan electrodes Y is adjusted as described above has already been described above in detail. Further description thereof will be omitted for simplicity.

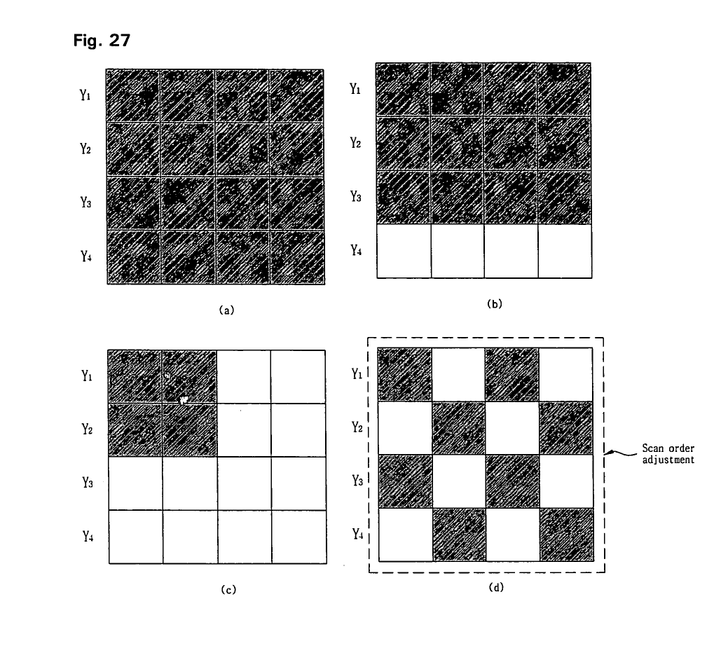

FIG. 27 is a view illustrating an example of a method of controlling a scan order by setting a critical value depending on an image data pattern.

Referring to FIG. 27, (a) of FIG. 27 shows a case where image data are all high level, i.e., the logic level “1”. (b) of FIG. 27 shows a case where image data are all the logic level “1” on Y1, Y2 and Y3 scan electrode lines and are all the logic level “0” on a Y4 scan electrode line. (c) of FIG. 27 shows a case where the first and second of Y1 and Y2 scan electrodes are the logic level “1” and the third and fourth of the Y1 and Y2 scan electrodes are the logic level “0”, and image data are all the logic level “1” on Y3 and Y4 scan electrode lines. (d) of FIG. 27 shows a case where the logic levels “1” and “0” are alternately disposed.

In this case, in (a) of FIG. 27, since the data driver IC is not switched, a total of a switching number is 0. In (b) of FIG. 27, a total of four switching numbers of the data driver IC is generated in up and down directions. In (c) of FIG. 27, a total of twice switching numbers is generated in up and down directions and a total of twice switching numbers is generated in right and left directions. In (d) of FIG. 27, a total of twelve switching numbers is generated in up and down directions and a total of twelve switching numbers is generated in right and left directions. It can be seen that the case of (d) of FIG. 27 has the highest load depending on the pattern.

A load value according to the pattern of the data has been already described in detail. It is preferred that the load value is the sum of a load value in the horizontal direction of a corresponding data pattern and a load value in the vertical direction of a corresponding data pattern.

Assuming that a previously set critical load value is a load depending on a total of ten switching numbers in up and down directions and a total of ten switching numbers in right and left directions, only the case of the last pattern (d) of the patterns (a), (b), (c) and (d) exceeds the previously set critical load value.

What the meaning that the critical load value is exceeded as described above refers to that an amount of a displacement current according to a pattern of data exceeds a preset critical current can be seen through the above description of the present invention.

In this case, in the pattern (d), when the image data are supplied, the scan order of the scan electrodes Y can be controlled. To control the scan order of the scan electrodes Y has already been described in detail. Description thereof will be omitted in order to avoid redundancy.

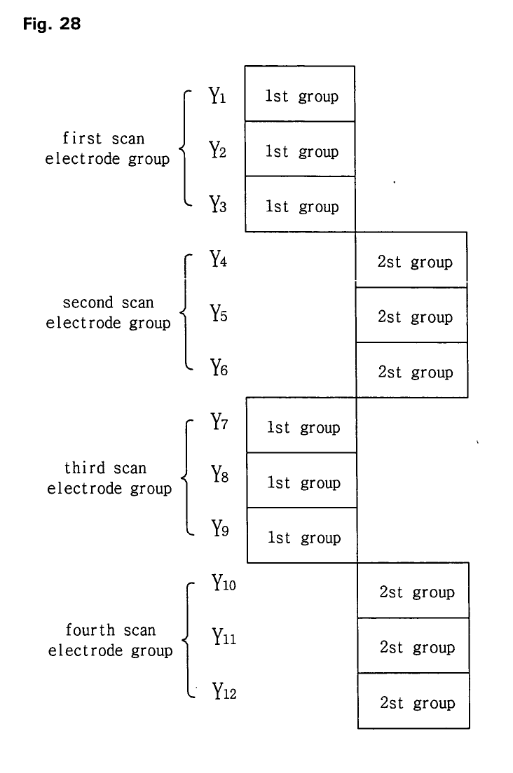

FIG. 28 is a view illustrating an example of a method of deciding a scan order corresponding to scan electrode groups, each comprising a plurality of scan electrodes Y.

Referring to FIG. 28, Y1, Y2 and Y3 scan electrodes are set as a first scan electrode group, Y4, Y5 and Y6 scan electrodes are set as a second scan electrode group, Y7, Y8 and Y9 scan electrodes are set as a third scan electrode group, and Y10, Y11 and Y12 scan electrodes are set as a fourth scan electrode group. It has bee shown in FIG. 28 that each scan electrode group is set to comprise four scan electrodes. It is, however, to be understood that

Furthermore, one or more of a plurality of scan electrode groups can be set to comprise a different number of scan electrodes Y from the remaining scan electrode groups. For example, two scan electrodes Y can be comprised in a first scan electrode group and four scan electrodes Y can be comprised in a second scan electrode group.

In the case where the scan electrode groups are set as described above, if the second type (Type 2) of FIG. 14 is applied, the third scan electrode group is scanned after scanning the first scan electrode group and the second and fourth scan electrode groups are then sequentially scanned, as in FIG. 28. In other words, the scan order is Y1, Y2, Y3, Y7, Y8, Y9, Y4, Y5, Y6, Y10, Y11 and Y12.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plurality of scan electrodes;
a plurality of data electrodes intersecting the scan electrodes;
a scan driver for supplying scan pulses to the plurality of scan electrodes according to any one of two or more different scan pulse supply orders; and
a data driver for supplying at least one data pulse, which corresponds to one scan pulse and has an application time point different from an application time point of the scan pulse, to the data electrodes.

2. The plasma display apparatus of claim 1, wherein the scan driver supplies the scan pulse according to the scan pulse supply order in which a displacement current of incoming image data is the lowest.

3. The plasma display apparatus of claim 2, wherein the scan electrodes comprise a first scan electrode and a second scan electrode, and the data electrodes comprise a first data electrode and a second data electrode, and
a first discharge cell and a second discharge cell are disposed at the intersections of the first scan electrode and the first and the second data electrodes, and a third discharge cell and a fourth discharge cell are disposed at the intersections of the second scan electrode and the first and the second data electrodes, and
the scan driver calculates a displacement current for the first discharge cell by comparing data of the first to fourth discharge cells.

4. The plasma display apparatus of claim 3, wherein the scan driver obtains a first result of comparing data of the first discharge cell and data of the second discharge cell, a second result of comparing the data of the first discharge cell and data of the third discharge cell, and a third result of comparing the data of the third discharge cell and data of the fourth discharge cell, decides a calculation equation of the displacement current through a combination of the first to third results, and calculates a total displacement current of the first discharge cell by summing the displacement currents calculated using the decided calculation equation.

5. The plasma display apparatus of claim 4, wherein assuming that a capacitance between the adjacent data electrodes equals Cm1, and a capacitance between the data electrode and the scan electrode and a capacitance between the data electrode and the sustain electrode equals Cm2, the scan driver calculates the displacement current according to a combination of the first to third results based on Cm1 and Cm2.

6. The plasma display apparatus of claim 2, wherein the scan driver calculates the displacement current of each sub-field of one frame, and supplies the scan pulse according to the scan pulse supply order in which the displacement current is the lowest each sub-field.

7. The plasma display apparatus of claim 2, wherein the scan pulse supply order comprises a first scan pulse supply order in which a scan pulse is supplied to the scan electrodes with them being divided into a plurality of groups, and
the scan driver consecutively supplies the scan pulse to scan electrodes belonging to the same scan electrode group in the case where a scan pulse supply order in which the displacement current is the lowest is the first scan pulse supply order.

8. The plasma display apparatus of claim 1, wherein the scan driver calculates a displacement current corresponding to each of the plurality of scan pulse supply orders according to incoming image data, and supplies the scan pulse to the scan electrodes according to at least one of scan pulse supply orders in which the displacement current is lower than a preset critical displacement current, of the plurality of scan pulse supply orders.

9. The plasma display apparatus of claim 1, wherein the plurality of data electrodes is divided into two or more data electrode groups, and the data electrode groups comprise one or more data electrodes.

10. The plasma display apparatus of claim 9, wherein the data electrode groups comprise the same number of data electrodes or a different number of data electrodes.

11. The plasma display apparatus of claim 9, wherein the data driver supplies the data pulse to all of the data electrodes comprised in one data electrode group at the same application time point.

12. The plasma display apparatus of claim 9, wherein the data driver sets a difference in an application time point between two or more data pulses corresponding to the one scan pulse to be the same or different.

13. The plasma display apparatus of claim 12, wherein the data driver sets a difference in an application time point between two or more data pulses corresponding to the one scan pulse to range from 10 ns to 1000 ns.

14. The plasma display apparatus of claim 12, wherein the data driver sets a difference in an application time point between two or more data pulses corresponding to the one scan pulse to have a value ranging from 1/100 to 1 times of a predetermined scan pulse width.

15. A plasma display apparatus comprising:
a plasma display panel in which a plurality of scan electrodes and a plurality of data electrodes intersecting the scan electrodes are formed;
a scan driver for supplying a scan pulse to the scan electrodes by setting a scan order of the plurality of scan electrodes in a second data pattern different from a first data pattern of data patterns of incoming image data to be different from the scan order of the first data pattern; and
a data driver for supplying at least one data pulse, which corresponds to one scan pulse and has an application time point different from an application time point of the scan pulse, to the data electrodes.

16. The plasma display apparatus of claim 15, wherein any one of a data load value of the first data pattern and a data load value of the second data pattern is more than a preset critical load value.

17. The plasma display apparatus of claim 16, wherein a data load value depending on the data pattern is obtained by the sum of a data load value in a horizontal direction of a data pattern and a data load value in a vertical direction of the data pattern.

18. The plasma display apparatus of claim 15, wherein any one of a displacement current of the first data pattern and a displacement current of the second data pattern is more than a preset critical current.

19. A method of driving a plasma display apparatus comprising a plurality of scan electrodes and a plurality of data electrodes intersecting the scan electrodes, the method comprising the steps of:
supplying scan pulses to the plurality of scan electrodes according to any one of two or more different scan pulse supply orders; and
supplying at least one data pulse, which corresponds to one scan pulse and has an application time point different from an application time point of the scan pulse, to the data electrodes.

20. A method of driving a plasma display apparatus comprising a plurality of scan electrodes and a plurality of data electrodes intersecting the scan electrodes, the method comprising the steps of:
supplying a scan pulse to the scan electrodes by setting a scan order of the plurality of scan electrodes in a second data pattern different from a first data pattern of data patterns of incoming image data to be different from the scan order of the first data pattern; and
supplying at least one data pulse, which corresponds to one scan pulse and has an application time point different from an application time point of the scan pulse, to the data electrodes.
